(19) United States
(12) Patent Application Publication
(10) Pub. No.: US 2016/0000071 A1
(43) Pub. Date: Jan. 7, 2016

(54) PHOTODEGRADABLE, BIOCOMPATIBLE AND EFFICIENT NANO-ENCAPSULATED FORMULATION

(71) Applicants: Nargess Memarizadeh, Isfahan (IR); Mohsen Adeli, Khoramabad (IR); Mohammad Ghadamyari, Rasht (IR)

(72) Inventors: Nargess Memarizadeh, Isfahan (IR); Mohsen Adeli, Khoramabad (IR); Mohammad Ghadamyari, Rasht (IR)

(21) Appl. No.: 14/853,945

(22) Filed: Sep. 14, 2015

Related U.S. Application Data
(60) Provisional application No. 62/049,426, filed on Sep. 12, 2014.

(51) Int. Cl. A01N 25/28; A01N 47/38; A01N 43/50

(52) U.S. Cl. CPC A01N 25/28; A01N 43/50; A01N 47/38

(57) ABSTRACT

An encapsulated formulation includes an active agent and at least one encapsulating material. The active agent includes at least one chemical pesticide. The at least one encapsulating material includes at least one triblock copolymer and is configured to encapsulate the active agent.

### CROSS REFERENCE TO RELATED APPLICATION

The present application claims priority from pending U.S. Provisional Patent Application Ser. No. 62/049,426 filed Sep. 12, 2014 entitled “Photodegradable, biocompatible and efficient nano-pesticides, using linear-dendritic copolymers”, the subject matter of which is incorporated by reference herein in its entirety.

### SPONSORSHIP STATEMENT

This application has been sponsored by the Iranian Nanotechnology Initiative Council, which does not have any rights in this application.

### TECHNICAL FIELD

The present application generally relates to photodegradable, biocompatible and efficient nano-encapsulated formulations. More particularly, the present application relates to an encapsulated formulation of pesticides using linear-dendritic copolymers.

### BACKGROUND

The overuse of bulk pesticides can cause serious contamination to the ambient environment. Since effective concentrations of the nano particular forms of pesticides are expected to be much lower than those of bulk materials, the application of pesticides in nano form could address the environmental problems. In fact, controlled-released formulations of pesticides using nano-encapsulation can reduce the harmful effect of pesticides on non-target organisms.

Several attempts have been made in the art to develop nano-pesticide formulations, namely: preparing polymeric nanoparticles of the poorly soluble pyrethroid insecticide bifenthrin by flash nano-precipitation to achieve a particle size in the range of 60-200 nm; conjugating sodium dodecyl sulfate (SDS) by photocatalytic TiO₂/Ag nanomaterial with dimethomorph and making a nano-pesticide; encapsulating of Imidacloprid (IMI) microcrystals directly using the natural poly saccharides chitosan and sodium alginate through layer-by-layer self-assembly; preparing the formulation of water dispersible nano-permethrin by solvent evaporation of oil in a water micro-emulsion for its larvicidal properties; and loading imidacloprid by meso-porous silica nanoparticles with different pore sizes, morphologies and structures.

However, a significant drawback of the abovementioned methods is the presence of hazardous materials in the formulation. Therefore, there is a need in the art to address the aforementioned drawback, and to improve the efficiencies of pesticides, as well.

According to the art disclosed in the literature, using dendrimers to interact with labile or poorly soluble drugs, may enhance drug stability and bioavailability. Thus, encapsulation of a pesticide within a dendrimer would have the same property as the pesticide itself, and it provides a means of controlling the release of the pesticide.

Hence, there is a need to provide an encapsulated formulation using biocompatible linear dendritic copolymers with higher efficiency and lower environmental risks, as well as, decreasing the dosage and the frequency of use of pesticides.

### SUMMARY

In one general aspect, the instant application describes an encapsulated formulation includes an active agent and at least one encapsulating material. The active agent includes at least one chemical pesticide. The at least one encapsulating material includes at least one triblock copolymer and is configured to encapsulate the active agent.

The above general aspect may include one or more of the following features. The pesticide can be selected from a group consisting of insecticide, herbicide, algicides or algaecides, miticides, acaricides, rodenticides, virucides, nematicide, termiticide, molluscicide, antimicrobial, fungicide, disinfectant (antimicrobial), sanitizer and derivation thereof.

In one implementation, Imidacloprid (C₉H₁₀ClN₅O₂) as a neonicotinoid insecticide (IMI); and lndoxacarb (C₂₂H₁₇ClF₃N₃O₇) as an effective indeno-oxadiazine insecticide (IND) may be selected as EXAMPLES, to be encapsulated pursuant to the teachings of the present application.

In another implementation, a linear dendritic triblock copolymer may be used, which may include poly (citric acid)-poly (ethylene glycol)-poly (citric acid) (PCA-PEG-PCA). In another implementation, a photocatalytic compound may be grafted to the linear-dendritic copolymers, wherein the photocatalytic compound may include TiO₂ nanoparticles. The TiO₂ nanoparticles are grafted to the linear-dendritic copolymers. In another implementation, two methods may be chosen to minimize the risks associated with pesticides, and increase their efficiency. The first method may be developing a nano-encapsulated formulation with controlled release properties, and the second method may be an advanced oxidation process (AOP) using TiO₂ nanoparticles.

In still another implementation, a nano form of imidacloprid (nano-IMI) and two nano-forms of indoxacarb (nano-IND) may be prepared via supramolecular interactions.

In still another implementation, to enhance the effectiveness of the pesticides, particle size of at least about 10 nanometer was achieved for encapsulating. In another implementation, said active component in the formulation may include 30 to about 80 weight percent of the total weight of the encapsulated formulation. In yet another implementation, pH dependent selective action of nano-formulation may be proved by simulation of cell membrane.

In another general aspect, the instant application describes a method for preparing a biocompatible encapsulated formulation containing an active agent, the method includes steps of preparing at least one encapsulating material, wherein said encapsulating material includes at least one triblock copolymer; dissolving the prepared encapsulating material in an organic solvent; dissolving an active agent in an organic solvent, wherein said active agent includes at least one pesticide; mixing the dissolved encapsulating material with the dissolved active agent; and removing impurities from the mixture to form the encapsulated formulation.

In another general aspect, the instant application describes a method for preparing an encapsulated formulation. The method includes the steps of preparing at least one encapsulating material, wherein the encapsulating material includes at least one triblock copolymer; dissolving the prepared encapsulating material in an organic solvent; dissolving an active agent in an organic solvent, wherein said active agent includes at least one pesticide; dispersing at least one photocatalytic compound in an organic solvent; ultrasonicating said dispersed photocatalytic compound; grafting the prepared encapsulating material with the ultrasonicated photo catalytic compound; admixing said dissolved active agent with the grafted encapsulating material; and removing impurities from the mixture.

Due to the high efficiency of the nano-encapsulated pesticides, which are prepared pursuant to the teachings of the instant application, the frequency of spraying of the pesticides can be reduced, which is beneficial to the environment.

The foregoing and other objects, features, aspects and advantages of the present application will become more apparent from the following detailed description of the present application when taken in conjunction with the accompanying DRAWINGS.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1A illustrates the ¹H NMR spectra of (a) nano-IMI in the mixture of D₂O and Acetone-d₆; (b) imidacloprid in Acetoned₆; and (c) PCA-PEG-PCA copolymers in D₂O.

FIG. 1B illustrates the ¹³C NMR spectra of (a) nano-IMI in mixture of D₂O and Acetoned₆; (b) imidacloprid in Acetone-d₆; and (c) PCA-PEG-PCA copolymers in D₂O.

FIG. 1C illustrates the IR spectra of (a) imidacloprid; (b) PCA-PEG-PCA copolymers; and (c) nano-IMI.

FIG. 1D illustrates the TGA diagrams for (a) nano-IMI; (b) PCA-PEG-PCA copolymers; and (c) imidacloprid

FIG. 2A illustrates the TEM image of encapsulated imidacloprid by products of PCA-PEG-PCA copolymers molecular self-assembly in ethanol.

FIG. 2B illustrates the TEM image of encapsulated imidacloprid by products of PCA-PEG-PCA copolymers molecular self-assembly in water.

FIG. 2C illustrates the optical microscopy images of globular segments resulted from ethanol solution of PCA-PEG-PCA copolymers (12.5 g/l ) and imidacloprid (2500 mg/l ), after 20 day.

FIG. 2D illustrates the optical microscopy images of tube particles resulted from water solution of PCA-PEG-PCA copolymers (12.5 g/l ) and imidacloprid (2500 mg/l ), after 3 day.

FIG. 2E illustrates the optical microscopy images of fibers resulted from water solution of PCA-PEG-PCA copolymers (250 mg/l ) and imidacloprid (50 mg/l ), after 10 day.

FIG. 3 illustrates the release rate percentage of imidacloprid from nano-capsule, at neutral pH and optimum pH of G. pyloalis larva's gut.

FIG. 4A. Comparison of LC50 values of bulk and nano form of imidacloprid using leaf dip bioassay over 5 days on G. pyloalis larva.

FIG. 4B. Comparison of LC₅₀ values of bulk and nano form of imidacloprid using topical bioassay over 4 days on G. pyloalis larva.

FIG. 5A illustrates IR spectra of (a) PCA-PEG-PCA Copolymer-TiO₂; (b) PCA-PEG-PCA copolymers; (c) lndoxacarb; ; (d) nano-IND; (e) nano-IND/TiO₂; and (f) TiO₂ nanoparticles.

FIG. 5B illustrates ¹H NMR spectra of (a) nano-IND/TiO₂; (b) nano-IND in mixture of D₂O and Acetoned₆; (c) indoxacarb in Acetoned₆; and(d)PCA-PEG-PCA copolymers in D₂O.

FIG. 5C illustrates ¹³C NMR spectra of (a) nano-IND/TiO₂; (b) nano-IND in mixture of D₂O and Acetoned₆; (c) indoxacarb in Acetoned₆; and (d)PCA-PEG-PCA copolymers in D₂O.

FIG. 6A illustrates Transmission electron microscopy (TEM) image of encapsulated nano-IND by products of PCA-PEG-PCA copolymers molecular self-assembly.

FIG. 6B illustrates Transmission electron microscopy (TEM) image of encapsulated nano-IND/TiO₂ by products of PCA-PEG-PCA copolymers molecular self-assembly.

FIG. 7. The UV-vis absorbance spectra of nano-IND, PCA-PEG-PCA Copolymers, lndoxacarb, TiO₂ nanoparticles and nano-IND/TiO₂ in ethanol.

FIG. 8 illustrates the accumulative release percentage of indoxacarb from two nano-formula, at neutral pH and optimum pH of G. pyloalis larva's gut.

FIG. 9. Comparison of LC₅₀ values of bulk and nano forms of indoxacarb using leaf dip bioassay over 5 days on G. pyloalis larva.

### DETAILED DESCRIPTION

The following detailed description is presented to enable any person skilled in the art to make and use the teachings of the instant application. For purposes of explanation, specific nomenclature is set forth to provide a thorough understanding of the present application. However, it will be apparent to one skilled in the art that these specific details are not required to practice the teachings of the instant application. Descriptions of specific applications are provided only as representative examples. Various modifications to the described implementations will be readily apparent to one skilled in the art, and the general principles defined herein may be applied to other implementations and applications without departing from the scope of the present application. The present application is not intended to be limited to the implementations shown, but is to be accorded the widest possible scope consistent with the principles and features disclosed herein.

The objective of the instant application is to provide an encapsulated formulation using biocompatible linear dendritic copolymers with higher efficiency and lower environmental risks, as well as, decreasing the dosage and the frequency of use of pesticides. The encapsulated formulation may include encapsulated pesticide formulation using copolymers to minimize the environmental risks of pesticides, besides enhancing their efficiency, and a method for preparing the same.

Moreover, using a simple set up for preparation of a biocompatible polymeric nano-formulation with suitable loading and controlled release properties is another object of the present application. Furthermore, one of the most important aspects of the present application, in addition to the controlled release property is the photo-degradation of the pesticide under UV or even sun light without any catalyst, which generally occurs after the optimal period of pest control. These and many other objects are met in various implementations of the present application, offering significant advantages over the prior art and consequent benefits to all mankind.

Encapsulation of pesticides with a biocompatible copolymer such as poly (citric acid)-poly (ethylene glycol)-poly (citric acid) (referred to hereinafter as PCA-PEG-PCA); ABA type linear dendritic copolymers is described in the present application and the effectiveness and biodegradability of the encapsulation formulation is evaluated and confirmed, as described in more detail in connection with specific implementations of the present application.

Citric acid molecules form a dendritic structure of PCA-PEG-PCA copolymers, which has a high degree of molecular uniformity and mono-dispersity, as well as, a highly functional surface. It is one of the most versatile and important carboxylic acid intermediates of metabolism in most plants and animals. Poly (ethylene glycol) (PEG) as linear poly ether hydrophilic blocks is used to modify dendrimers in drug delivery systems. The PEG is typically conjugated to the surface of a dendrimer to provide high water solubility, bio compatibility and the ability to modify the bio-distribution of carriers.

Molecular self-assemblies of copolymers such as PCA-PEG-PCA enable it to encapsulate pesticides. As is discussed in more detail hereinbelow, this property of PCA-PEG-PCA copolymer improves the efficiency of the pesticide, which, in turn, leads to a decrease in the dosage and the frequency at which the pesticides are used. Moreover, these biodegradable and biocompatible copolymers do not add pollutants to the environment.

Moreover application of biocompatible ABA triblock linear-dendritic copolymers or these copolymers being grafted onto TiO₂ nanoparticles as a photocatalytic compound for nanoencapsulation and photolysis degradation of the selected pesticides is disclosed in the present application.

Besides, the photocatalytic degradation of pesticides under UV and natural light is a unique advantage of PCA-PEG-PCA copolymers. This unique characteristic of these biocompatible copolymers, offer an efficient solution to reduce the environmental pollution.

### Pesticides

Various pesticides including insecticide, herbicide, algicides or algaecides, miticides, acaricides, rodenticides, virucides, nematicide, termiticide, molluscicide, antimicrobial, fungicide, disinfectant (antimicrobial), and sanitizer and the derivation thereof, can be used as the active agent in the encapsulated formulation. However, in some implementations of the present application, two pesticides were selected and used for the preparation of the nano-encapsulated formulations, namely, Imidacloprid (C₉H₁₀ClN₅O₂) as a neonicotinoid insecticide (referred to hereinafter as IMI); and lndoxacarb (C₂₂H₁₇ClF₃N₃O₇) as an effective indeno-oxadiazine insecticide (also referred to hereinafter as IND).

One nano form of imidacloprid and one nano forms of indoxacarb were prepared via supramolecular interactions, which employed direct self-assembly of biocompatible (PCA-PEG-PCA) ABA type linear-dendritic copolymers. Moreover, the second form of indoxacarb could be prepared as nano-IND/TiO₂ which use self-assembly of PCA-PEG-PCA copolymers grafted to TiO₂ nanoparticles. The insecticidal efficiency and rate of degradation of the nano-IND/TiO₂ and nano-IND were investigated and compared with those of the technical indoxacarb.

### Synthesis of PCA-PEG-PCA Copolymers

The materials, which were used for synthesizing PCA-PEG-PCA copolymers in three polymerization steps are PEG (Mn=1000) and citric acid (molar ratio of CA/PEG=1/10). In the first step, the temperature of polymerization was increased to 110° C. for 20 minutes to form a transparent viscose compound. In the second step, the temperature was increased to 130° C. to the melting state for 15 minutes. In the third step, the temperature was maintained at 150° C. for 30 minutes, while the mixture was stirred vigorously. During these steps, water resulted from reaction was removed from the reaction medium by a vacuum pump. After these steps, the Ampule contents were dissolved in tetrahydrofuran and then precipitated in diethyl ether for about 3 to 7 times. The PCA-PEG-PCA copolymers formed a viscous yellow compound with a yield of 8 percent of the initial concentration.

### Synthesis of TiO₂-Nanoparticles (TiO₂-NPs)

TiO₂ nanoparticles were prepared by hydrolyzing titanium isopropoxide, which was added drop by drop into a stock solution (i.e. ethanol and acetic acid in a ratio of 8:3 v/v with glycerol) at 10° C., followed by rigorous stirring under argon atmosphere for 3 hours. Then, the solutions were heated at 60° C. for 5 hours or until the gelling reaction was completed. The dried precipitates were heated at 400° C. for 10 hours with a heating rate of 1° C./minute.

### The Insects

The insects used in the present application is Glyphodes pyloalis Walker (Lepidoptera: Pyralidae) which was collected from infested mulberry orchards in the vicinity of Rasht, Iran. Mass rearing of insects was carried out in the laboratory under controlled conditions at 25±1° C., 70±5% RH and 16:8 L:D. Newly-ecdysed fifth instar larvae of G. pyloalis were used for the bioassay experiments. The Glyphodes pyloalis Walker hereinafter is referred to as G. pyloalis.

### EXAMPLE 1

### Encapsulation of Imidacloprid by PCA-PEG-PCA Copolymers Molecular Self-Assembly (Nano-IMI)

Preparation of Nano-Imidacloprid (nano-IMI)

In this example, imidacloprid is dissolved in acetone with a ratio of about 1 g/100 ml and PCA-PEG-PCA copolymers are dissolved in ethanol as a basic solvent with a ratio of about 1 g/20 ml. Then, they were mixed at room temperature and stirred for 8 hours using a dialysis bag with a Mn cutoff of 2000. Afterwards, the free imidacloprid was separated and the resultant solution containing nano-IMI was maintained at 4° C. The solution was diluted in two solvents (ethanol and deionized water) for bio-assaying and other experiments.

### Determination of Loading Capacity of PCA-PEG-PCA Copolymers

A certain amount of nano-IMI was prepared and sealed in a dialysis bag. Then, the dialysis bag was immersed in the phosphate-buffered saline solution (PBS) which was stirred with a magnetic stirrer at a fixed speed at room temperature for about 30 minutes. This experiment was done at two pH values (pH of 7 and 10) for the PBS. The concentration of encapsulated imidacloprid in the formulation was determined using UV absorbance at λₘₐₓ=268 nm.

The percentage of encapsulation was calculated as:

% encapsulation={(total imidacloprid concentration-free imidacloprid concentration)/total imidacloprid concentration}*100

Determination of Release Rate of Imidacloprid from Nano-Formulations

The fluid released from the dialysis bag contained a certain amount of encapsulated imidacloprid into the PBS buffer. The mixture was stirred using a magnetic stirrer at a fixed speed at room temperature; After 1, 2, 3, 4, 6, 8, 24, 48 and 72 hours for nano-IMI, the concentration of the mixture was determined by means of UV absorbance at 268 nm and 276 nm at a neutral pH (7) for the PBS buffer and the common pH of Lepidopteran gut

The percentage of imidacloprid released was calculated using the following equation:

% release=(free imidacloprid concentration at each sample/total imidacloprid concentration)*100.

### Characterization of Nano-IMI

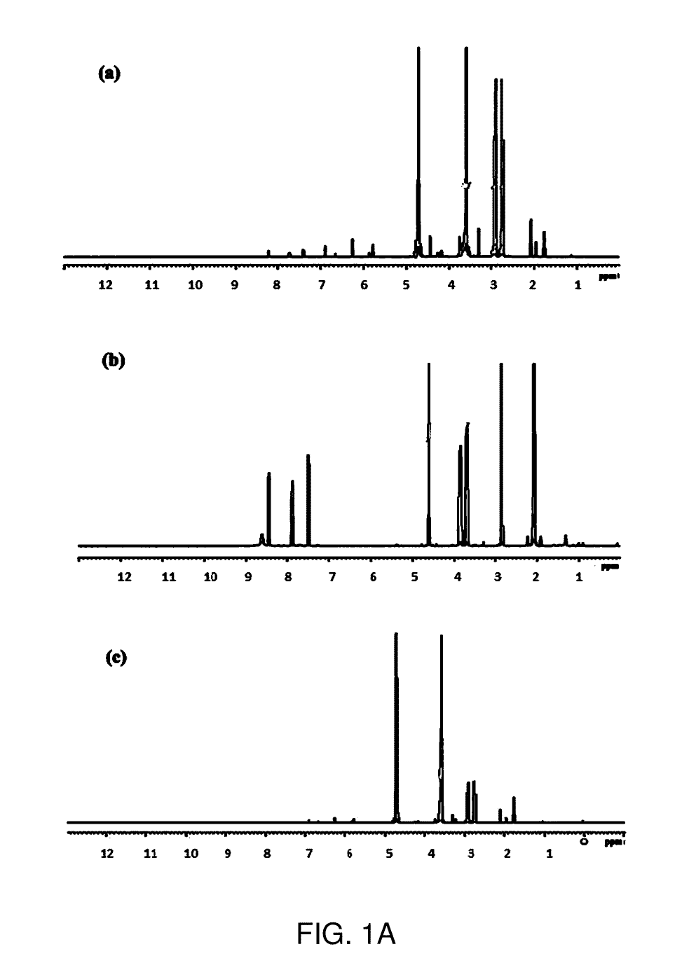

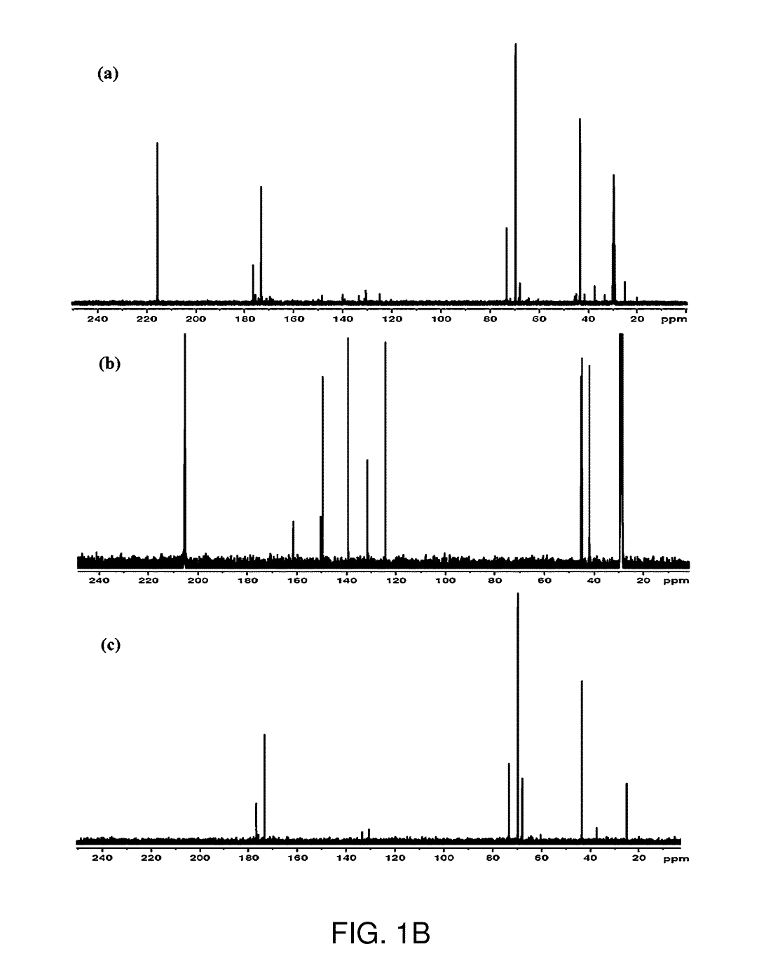

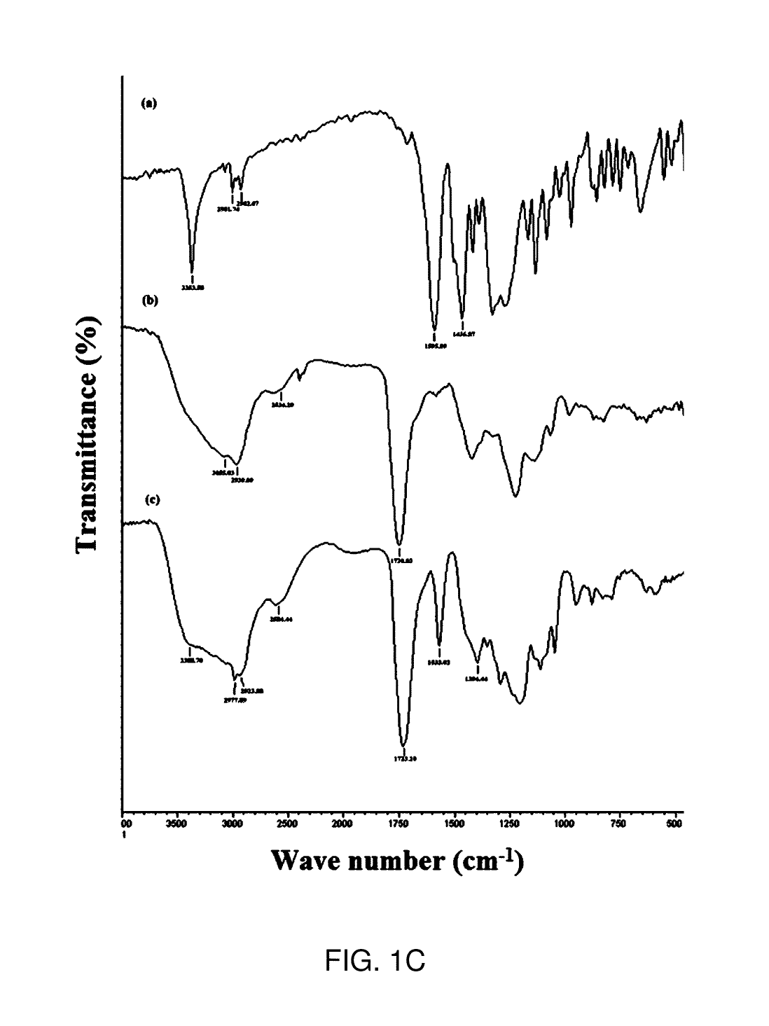

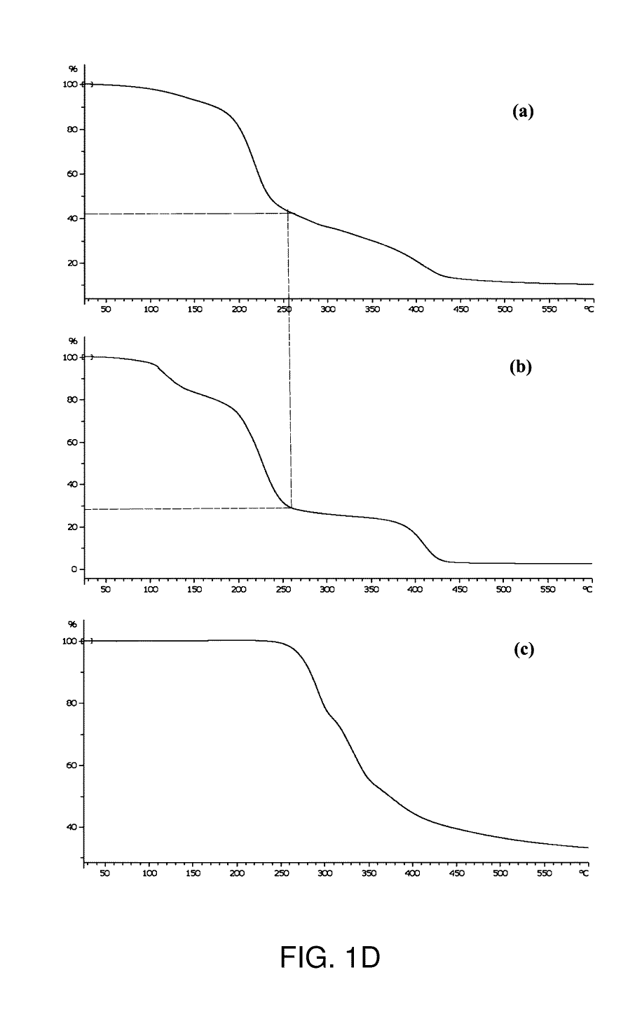

With reference to FIG. 1A of the DRAWINGS, the graph designated by letter (c) shows the ¹H NMR spectrum of copolymers, which reveals chemical shifts at 4.7 ppm for end methylene groups of PEG, 3.6 ppm for PEG methylene groups, and 2.6-2.8 ppm for methylene groups of PCA. The ¹H NMR spectrum of free imidacloprid, which is designated by letter (b) in FIG. 1A of the DRAWINGS, shows signals at 1.4, 2.8 and 3.81 ppm for the methylene groups. It also shows chemical shifts at 2 ppm for the amine group and at 7.84, 8.47 and 8.65 for protons of the pyridine ring. The ¹H NMR spectrum for nano-IMI, which is designated by letter (a) in FIG. 1A of the DRAWINGS, reflects chemical shifts correlating with the pyridine ring of imidacloprid at 7.74, 8.17 ppm and chemical shifts at 1.5-4.2 correlating to the methylene groups of imidacloprid and all signals for the PCA-PEG-PCA copolymers. As is known to those skilled in the art, the appearance of signals of the copolymers and imidacloprid with small shifts in the ¹H NMR spectrum of the nano-IMI confirms the encapsulation of the imidacloprid inside the molecular self-assemblies of copolymers and the successful preparation of the nano-IMI.

One implementation of the disclosed formulation is illustrated in FIG. 1B of the DRAWINGS. The ¹³C NMR spectrum of imidacloprid, which is designated by letter (b), shows signals at 123.5, 138.5, 145.9, 150.3, and 163 ppm that correspond to the carbons of the aromatic ring. The ¹³C NMR spectrum of nano-IMI, which is designated by letter (a), reflects chemical shifts at 35, 45, 47, 51, 63 and 65 ppm that correspond to the aliphatic methylene groups of the PCA-PEG-PCA copolymers which is designated by letter (c) and imidacloprid. As is known to those skilled in the art, the chemical shifts at 131, 149, 152 and 172 ppm correspond to the pyridine of the imidaclopridand at 176 ppm to the carbonyl groups of the PCA blocks of copolymers

With reference now to FIG. 10 of the DRAWINGS, the FTIR spectrum of the copolymers which is designated by letter (b), shows peaks at 2400-3600 cm⁻¹ and 1730 cm⁻¹ which correspond to the hydroxyl and carbonyl groups of the PCA blocks. The peak at 3354 cm⁻¹ in the imidacloprid IR spectrum as illustrated in FIG. 1C, that one is designated by letter (a), corresponds to the symmetric stretching vibrations of N—H and the peaks at 1437-1596 are the C=C and NO₂ stretching frequencies. The presence of nano-IMI particles led to a shift in some copolymers peaks or changes in their relative intensities as illustrated in FIG. 1C (c). In particular, the peak at 1730 cm⁻¹ in FIG. 1C of the DRAWINGS, which is designated by letter (b) shifted to 1723 cm⁻¹ in FIG. 1C (c) of the DRAWINGS, confirming hydrogen bonds between the PCA blocks of the copolymers and imidacloprid. The new peak appeared at 3389 cm⁻¹ as illustrated in FIG. 10 which is designated by letter (c), that again indicates hydrogen bonds between the N—H groups of imidacloprid and the carboxyl functional groups of the copolymers. These obvious changes suggest that imidacloprid and the copolymers interacted strongly and that imidacloprid became part of the nano-IMI molecular self-assembly

Thermal analysis was carried out at 0° C. to 600° C. at a heating rate of 10° C./min under nitrogen flow to compare the thermal stability of the synthesized nano-IMI with its components, the copolymers and free imidacloprid. With reference now to FIG. 1D of the DRAWINGS, which is designated by letter (b), TGA diagram of PCA-PEG-PCA copolymers, indicates three main weight-loss temperatures; the first one, which is between about 110 and about 180° C. corresponds to the evaporation of water and decarboxylation of the carboxyl functional groups of the PCA blocks. The second weight-loss, which is between about 190 to about 260° C. corresponds to the decomposition of the PCA blocks, and the third stage (between about 380 to about 430° C.) is for the decomposition of the PEG block. TGA diagram of imidacloprid as illustrated in FIG. 1D of the DRAWINGS, which is designated by letter (c), shows two stages of weight-loss corresponding to the start of decomposition at 250° C. and the point where decomposition reaches 66.4% at 550° C. The TGA diagram of nano-IMI, with reference to FIG. 1D of the DRAWINGS, which is designated by letter (a), indicates the start of decomposition at 150° C. and the weight of the compound slowly decreases to 11% at 440° C. The water molecules were replaced by imidacloprid when the starting point for decomposition increases to 150° C. Since weight loss for the PCA-PEG-PCA copolymers at 260° C. decreases from 72% to 58% for nano-IMI, it can be deduced that the amount of encapsulated imidacloprid was about 14%.

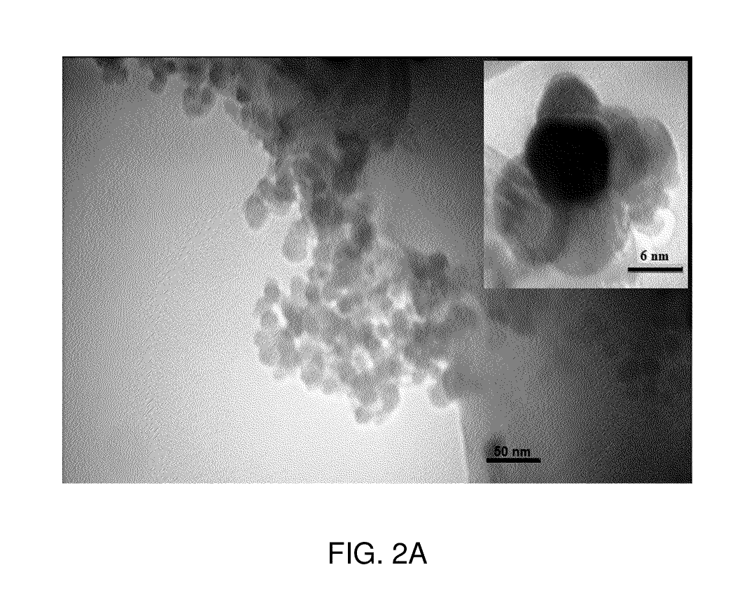

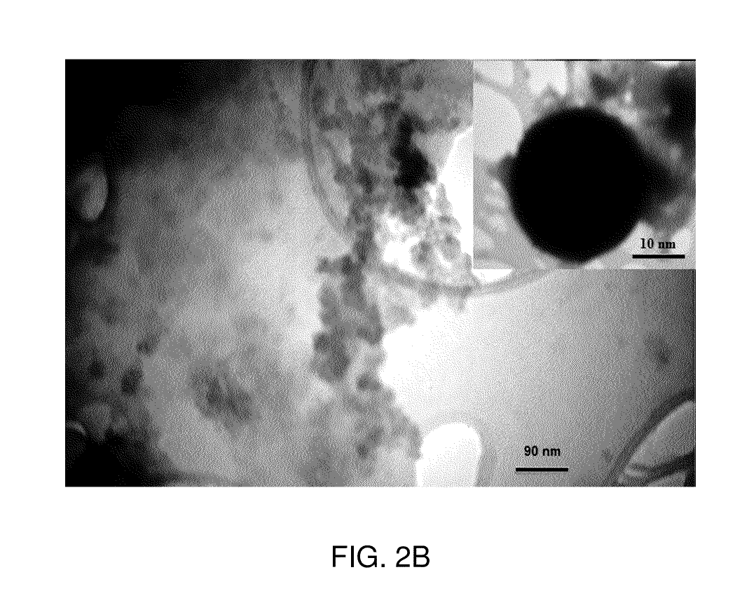

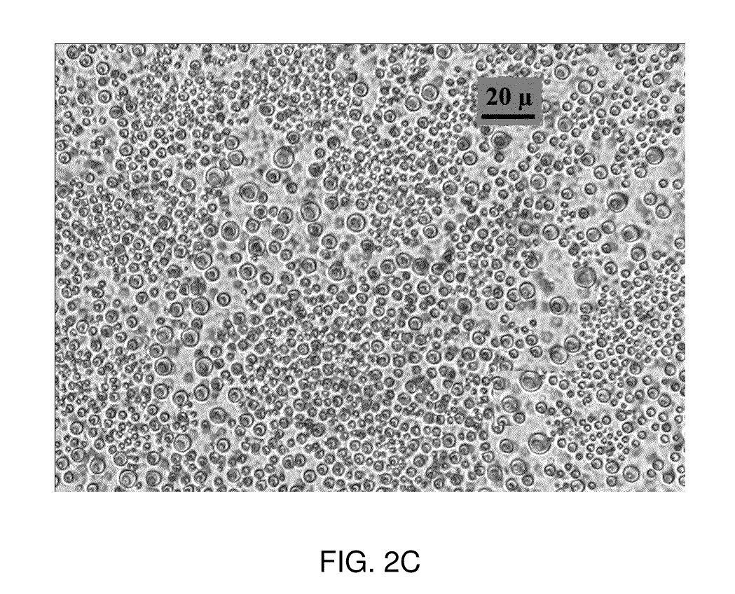

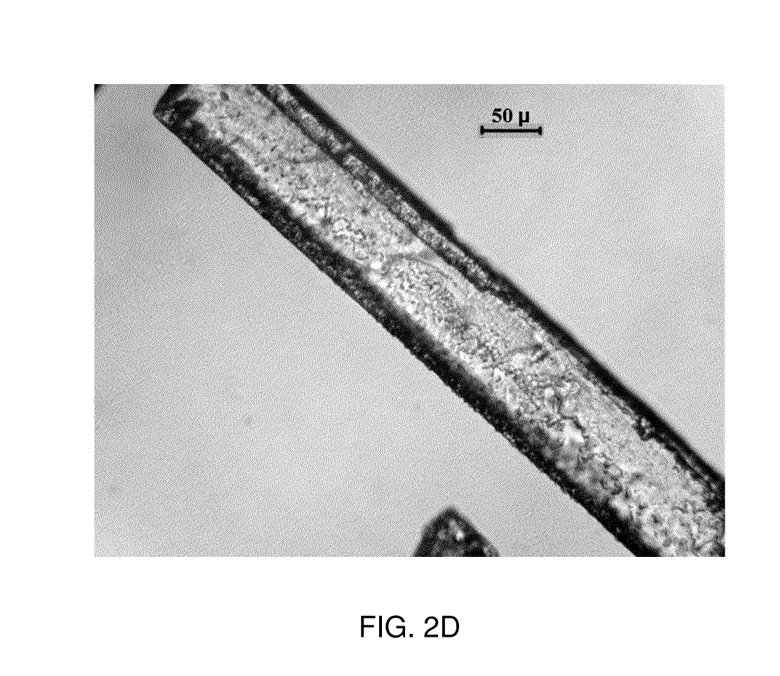

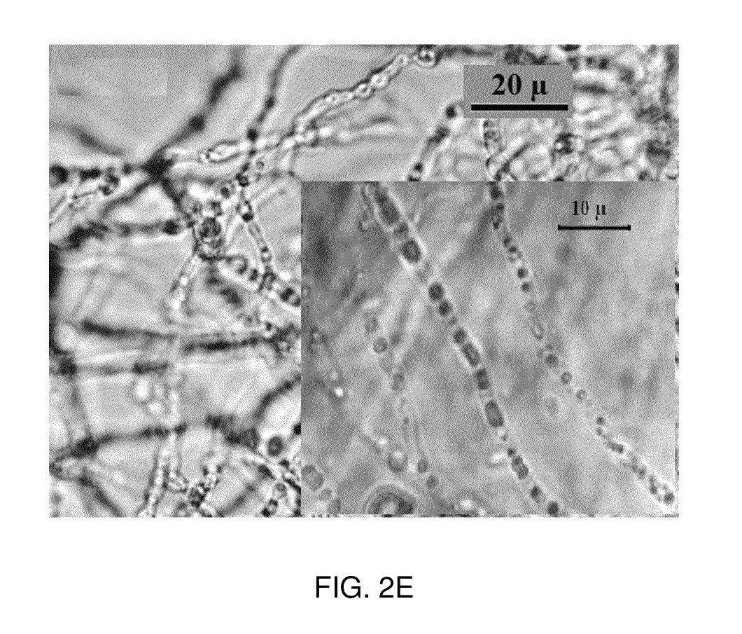

In one implementation, molecular self-assembly of the copolymers in ethanol and water in the presence of imidacloprid was investigated by using TEM images. FIG. 2A of the DRAWINGS, illustrates TEM images of spherical nanoparticles of imidacloprid, encapsulated in copolymers prepared in ethanol on the first day of the synthesis was revealed.

With reference to FIG. 2B of the DRAWINGS, TEM image of nano-IMI prepared by self-assembly of copolymers in water in the presence of imidacloprid on the first day is illustrated. The results of analysis indicate that molecular self-assembly of synthesized nano-IMI in water, led to the formation of semi-spherical nanoparticles.

FIG. 2A of the DRAWINGS illustrates the nano-IMI, prepared in ethanol with the imidacloprid particle in the center and the copolymers assembled around it. It is evident that the imidacloprid is encompassed in the core by PCA-PEG-PCA copolymers same as when water is used as solvent as was illustrated in FIG. 2B of the DRAWINGS

As is known to those skilled in the art, the size and the shape of supramolecular assemblies of PCA-PEG-PCA copolymers depend on the structure of the copolymers. Copolymers with larger PCA blocks produce fibers with greater diameters. The inventors of the present application have discovered that the type of the solvent, the concentration of copolymers and the presence of imidacloprid during encapsulation as a small guest molecule, affected the size and morphology of the supramolecular assemblies. When an ethanol solution with high concentrations of imidacloprid (about 2.5 gr/L) and copolymers (about 12.5 gr/L) was left at 4° C., globular supramolecular assemblies gradually appeared. Imidacloprid was encapsulated in the core of the globular capsules as illustrated in FIG. 2C of the DRAWINGS. In the presence of water as an initial solvent or for dilution, the size and shape of the supramolecular assemblies of the copolymers in the presence of imidacloprid differed strongly from that in the presence of ethanol. For high concentrations of the copolymers and imidacloprid, large tubular particles formed after two or three days as illustrated in FIG. 2D of the DRAWINGS.

FIG. 2E of the DRAWINGS indicates while low concentrations of copolymers was used in the presence of imidacloprid after about 10 days, fiber-shaped supramolecular assemblies appeared and the imidacloprid was encapsulated in segments of said fiber-shaped supramolecular assemblies. It is likely that the fiber-shaped, globular and tubular segments contained assembled PCA blocks since these blocks as dendritic architecture contain several functional groups that interact with imidacloprid. The open nature of dendritic architecture has led to the encapsulation of drug molecules within the branches of a dendrimer. The hydrophobicity of imidacloprid causes its attachment to PCA-PEG-PCA copolymers by electrostatic or other interactions in water and forces hydrophilic segments of copolymers (citric acid branches) to cover imidacloprid more completely than in the presence of an organic solvent such as ethanol. In fact, when nano-IMI was prepared in ethanol, only a globular self-assembly was produced. In spite of the interesting supramolecular self-assembly systems in the presence of water that verify good interaction between nano-IMI particles in water, the results also showed that, even after several months, the new nano-IMI formulation produced in ethanol shows no deposits, which confirms its stability.

### Loading Capacity of PCA-PEG-PCA Copolymers for Imidacloprid

The prevailing pH of the model insect gut is 9 to 11; thus, in addition to neutral pH (7) the effect of pH 10, as the optimal gut pH of G. pyloalis, on loading capacity and release rate was examined. The loading capacity of PCA-PEG-PCA copolymers was investigated using UV spectroscopy and a calibration curve was obtained by plotting the concentration of imidacloprid versus λmax. This calibration curve was used to determine the highest concentration of imidacloprid needed for a certain concentration of PCA-PEG-PCA copolymers to produce nano-IMI. This concentration was considered to be the maximum loading capacity of the copolymers.

The results revealed that the loading capacity of the copolymers at pH 7 was around 53% and at pH 10 was around 80%. During the preparation time of imidacloprid nanocapsules using about 1000 mg/L imidacloprid and about 5000 mg/L PCA-PEG-PCA copolymers, 53% of the free imidacloprid was loaded on the PCA-PEG-PCA copolymers and converted to nano-IMI at a PBS pH of 7, while the loaded percent of the free imidacloprid was 80% at a PBS pH of 10. Thermal analysis of the nano-capsules which prepared by using about 10 g/L imidacloprid and about 5 g/L copolymers in ethanol, showed that the amount of the encapsulated imidacloprid inside self-assemblies was around 14%.

In general, since the number of guest molecules incorporated into a dendrimer is dependent on the architecture of the dendrimer; loading capacity may be enhanced by the formation of a complex containing a large number of groups on the dendrimer surface. The external surfaces of the citric acid blocks of PCA-PEG-PCA have been investigated as dendrimers for potential sites of interaction with imidacloprid. In case of drug encapsulation, the number of surface groups available for drug interactions generally doubles with each increasing generation of dendrimer. Therefore, generation of PCA-PEG-PCA copolymers were effective for increasing potential sites of interaction with imidacloprid.

Release Rate of Imidacloprid from Nano-IMI

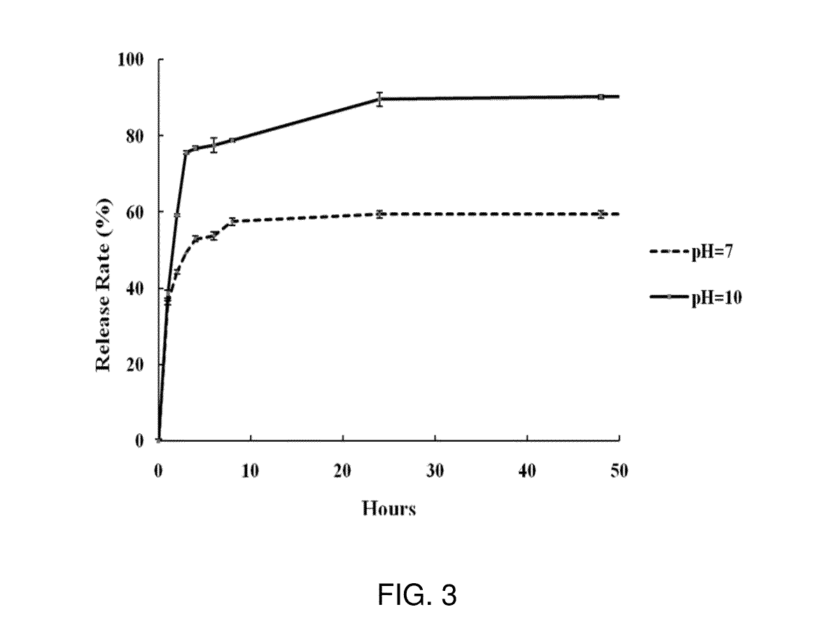

The concentration of imidacloprid released from the imidacloprid nanocapsules into the PBS buffer (pH=7) is illustrated in FIG. 3 of the DRAWINGS. In the implementation of FIG. 3, the percentage of the free imidacloprid in the PBS buffer (pH=7) increases in the imidacloprid release at this pH for 6 hours and then reaches a constant value and remains constant. The release rate of imidacloprid into high pH PBS buffer (pH=10) increases for about 24 hours. The results showed that, at the higher pH (pH=10), the release percentage of imidacloprid was higher than that at pH=7.

The selective behavior of nano-IMI at the pH of G. pyloalis gut (pH=10) (higher loading capacity and releasing time) confirms that it can be used as a pesticide formulation compatible with the objectives of sustainable agriculture. The results of the leaf dip bioassay further verify this claim.

### Insecticide Efficiency of Synthesized Nano-IMI

### Leaf Dip Bioassay

The toxicity of the encapsulated imidacloprid diluted in water for the newly-ecdysed fifth instar larvae of G. pyloalis was evaluated using leaf dip bioassay. The technical imidacloprid was dissolved in acetone and diluted to generate 6 serial dilutions with distilled water. Mulberry leaf discs with diameters of 3.5 cm were prepared, so that each petiole was placed in a vial containing water for providing moisture to the leaf discs for several days. These discs were then immersed in the dilutions for 45 seconds. Mortality was assessed after the treated larvae were maintained at 25±1° C., 70±10 R.H. for 24, 48, 72, 96 and 120 hours.

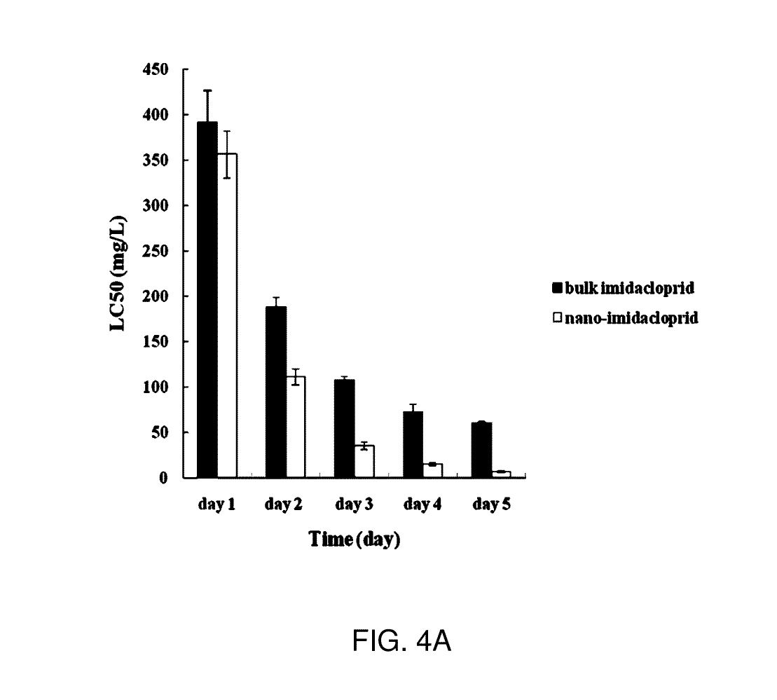

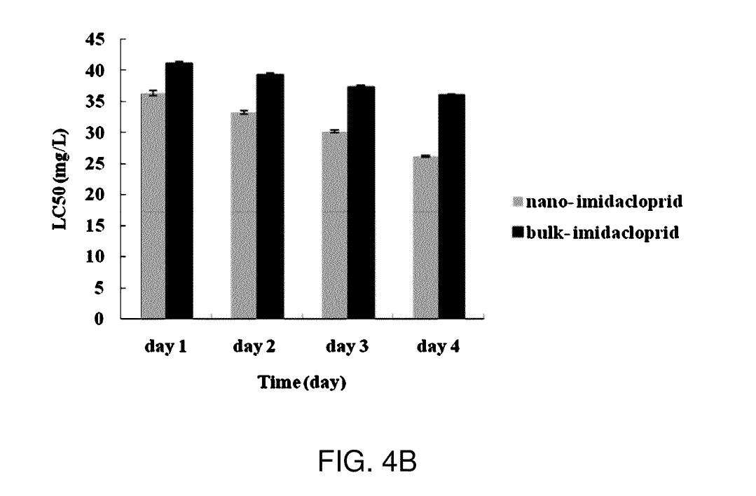

To determine the insecticidal efficiency of nano-IMI over the bulk imidacloprid diluted in water, leaf dip bioassay tests on the G. pyloalis were performed. For the concentration of about 500 ppm of free imidacloprid and an exposure time of 4 days, 100% mortality was observed. 100% mortality was also observed at the 300 ppm concentration of nano-IMI with an exposure time of 5 days. The results of analysis of variance (ANOVA) as well as mean comparison, as illustrated and described in more details in TABLE 1, indicated significant effects of concentration, time, and interaction of time and concentration in case of nano-IMI. When nano-IMI was used in the bioassay, mortality significantly increased; the effect of concentration correlated with the time of exposure and an increase in concentration over time (over 5 days). Despite the reduction of imidacloprid concentration, the exposure time for controlling increased while nano-IMI was used. These results verify that the effective materials were slowly released from the polymeral nano-capsules and remained on the target site for a greater length of time. Moreover, when time for control was increased, the consumption of pesticide decreased. A comparison of LC₅₀ for bulk and nano imidacloprid as illustrated in FIG. 4A showed that as exposure time increased, LC₅₀ for the nano-IMI remarkably decreased over free imidacloprid. After 4 days, this factor for nano-IMI decreased to 4.82 fold less than that of the bulk form of imidacloprid; after 5 days, this amount increased to 9.05 fold less. This result indicates that the nano form of imidacloprid shows better performance over bulk imidacloprid.

TABLE 1
Mortality percentage of newly ecdysed fifth instar larvae of G. pyloalis by leaf dip bioassay
method over the fifth day. Means followed by similar letters showed no significantly difference
from each other by Tukey's test (p < 0.05). “C” in TABLE 1 represents concentration.

| | C¹ | % mortality at times (h) after treatment | | | | |
|---|---|---|---|---|---|---|
| Insecticides | (ppm) | 24 | 48 | 72 | 96 | 120 |
| Nano- | 300 | 45.75 ± 2.52^{kl} | 65 ± 2.04^{ghij} | 88.75 ± 1.25^{abcd} | 95.5 ± 2.02^{ab} | 100 ± 0^{a} |
| imidacloprid | 183 | 42 ± 1.22^{l} | 61.25 ± 2.39^{efg} | 76.25 ± 2.39^{efg} | 93 ± 1.91^{abc} | 96 ± 1.58^{ab} |
| | 111 | 22.55 ± 2.63^{m} | 46.5 ± 2.36^{kl} | 70.41 ± 1.71^{fghi} | 85 ± 2.04^{bcde} | 92.25 ± 1.31^{abc} |
| | 68 | 20.41 ± 1.71^{m} | 44.75 ± 2.28^{kl} | 72.33 ± 2.33^{fgh} | 81.25 ± 2.52^{cdef} | 90.75 ± 0.75^{abc} |
| | 42 | 16.83 ± 1.45^{mn} | 40.75 ± 3.33^{l} | 55 ± 1.45^{jk} | 75.75 ± 2.46^{efg} | 85.5 ± 2.02^{bcde} |
| | 25 | 7.62 ± 1.43ⁿ | 19 ± 1^{mn} | 38.75 ± 3.33^{l} | 59.25 ± 1.65^{ij} | 78.25 ± 1.18^{def} |
| Imidacloprid | 500 | 57.5 ± 2.04^{defg} | 77.58 ± 4^{b} | 86.08 ± 1.63^{ab} | 100 ± 0^{a} | 100 ± 0^{a} |
| | 316 | 39.16 ± 4.13^{hijk} | 60 ± 3.16^{cde} | 75 ± 3.2^{bc} | 84.25 ± 3.37^{ab} | 86.25 ± 2.39^{ab} |
| | 200 | 34.16 ± 2.09^{jkil} | 55 ± 3.19^{efgh} | 71.66 ± 2.04^{bcd} | 78.75 ± 2.39^{b} | 80 ± 2.04^{b} |
| | 126 | 21.85 ± 3.07^{mnl} | 43.75 ± 2.39^{fghi} | 58.65 ± 3.41^{defg} | 76.25 ± 3.17^{b} | 78.75 ± 3.75^{b} |
| | 80 | 8.82 ± 1.38^{no} | 23.8 ± 2.52^{mno} | 39.58 ± 3.33^{hijk} | 57.75 ± 3.17^{defg} | 58.75 ± 3.75^{def} |
| | 50 | 2.5 ± 2^{o} | 15.61 ± 1.72^{mno} | 27 ± 3.33^{jklm} | 42.5 ± 2.5^{ghij} | 46.25 ± 2.39^{efghi} |

### Topical Bioassay

To determine the efficacy of the encapsulated nano-IMI prepared using ethanol, a topical bioassay was performed. In the preliminary tests, 5 concentrations of bulk and nano-IMI were tested. The lowest and highest doses were about 14.5 and 60 ppm for bulk-imidacloprid, respectively, and about 10 and 48 ppm for nano-IMI, respectively. Fifty larvae per concentration were used for all experiments and each experiment was replicated 4 times; 1 μl of the desired concentration was topically applied to the metathoracic tergum. The controls received 1 μl of ethanol in the same way. The treated larvae were allowed to eat fresh leaves. After 24, 48, 72 and 96 h, the numbers of dead larvae were recorded.

Topical bioassay was also used to evaluate the performance of nano-IMI prepared in ethanol. In this method, ethanol was used as a volatile solvent. The ANOVA and mean comparison in a split-plot in time design showed that as exposure time increased for both bulk and nano-IMI, the mortality rate of G. pyloalis increased significantly.

With reference now to TABLE 2, it is detected that the effect of concentration, time, and the interaction of time and concentration for nano- and bulk imidacloprid were significant. As illustrated in FIG. 4B, LC₅₀ after 24, 48, 72 and 96 hours revealed that at all exposure time, LC₅₀ was significantly lower for nano-IMI compared free imidacloprid. This means that less nano-IMI was necessary for an essential dose for pest control, which decreases probable environmental risk significantly. The topical bioassays confirmed that using the nano form of pesticide allowed successful delivery to the target sites and decreased loss of pesticide. In particular, the increased penetration of the effective material by means of citric acid molecules to the metathoracic tergum membrane cells of G. pyloalis larvae enhanced the effectiveness of nano-IMI prepared with ethanol.

TABLE 2
Mortality percentage of newly ecdysed fifth instar larvae
of G. pyloalis by topical bioassay method over the fourth
day. Means followed by similar letters showed no significantly
difference from each other by Tukey's test (p < 0.05).
C in the table represents concentration.

| | C¹ | % mortality at times (h) after treatment | | | |
|---|---|---|---|---|---|
| Insecticides | (ppm) | 24 | 48 | 72 | 96 |
| Nano- | 10 | 13.177 ± | 15.233 ± | 16.488 ± | 18.277 ± |
| imidacloprid | | 0.0968^{r} | 0.1452^{q} | 0.2474^{p} | 0.0909^{o} |
| | 14.5 | 21.355 ± | 23.144 ± | 26.622 ± | 30.233 ± |
| | | 0.1937ⁿ | 0.0987^{m} | 0.1746^{l} | 0.1452^{k} |
| | 22 | 31.322 ± | 35.133 ± | 38.144 ± | 41.655 ± |
| | | 0.1927^{j} | 0.0881^{h} | 0.0987^{g} | 0.0867^{f} |
| | 32 | 34.166 ± | 38.3 ± | 42.2 ± | 48.233 ± |
| | | 0.0881ⁱ | 0.1732^{g} | 0.115^{f} | 0.1452^{e} |
| | 48 | 67.147 ± | 70.033 ± | 72.819 ± | 78.790 ± |
| | | 0.0866^{d} | 0.0881^{c} | 0.117^{b} | 0.123^{a} |
| Imidacloprid | 14.5 | 16.188 ± | 18.061 ± | 20.023 ± | 20.016 ± |
| | | 0.240^{q} | 0.1428^{p} | 0.033^{o} | 0.0218^{o} |
| | 22 | 18.133 ± | 20.026 ± | 22.016 ± | 24.046 ± |
| | | 0.088^{p} | 0.0371^{o} | 0.0440ⁿ | 0.0785^{m} |
| | 32 | 33.044 ± | 35.033 ± | 36.542 ± | 38.244 ± |
| | | 0.155^{l} | 0.0881^{k} | 0.0632^{j} | 0.072ⁱ |
| | 47.5 | 49.966 ± | 52.06 ± | 54 ± | 56.026 ± |
| | | 0.088^{h} | 0.124^{g} | 0.0577^{f} | 0.0648^{e} |
| | 60 | 75.966 ± | 78.016 ± | 80.43 ± | 82 ± |
| | | 0.1452^{d} | 0.095^{c} | 0.058^{b} | 0.0346^{a} |

### EXAMPLE 2

### Encapsulation of Indoxacarb by PCA-PEG-PCA to Form Nano-Indaxacarb

### Preparation of Nano-Indoxacarb (Nano-IND)

The lndoxacarb was dissolved in acetone with a concentration of about 1 g/L and the PCA-PEG-PCA copolymers were dissolved in ethanol with a concentration of about 5 g/L. Then, these two were mixed at room temperature and stirred for 8 hours. Free indoxacarb was separated, using a dialysis bag, and then resultant solution containing nano-IND was used as a stock solution in the experiments.

### Preparation of Nano-Indoxacarb/TiO₂ (Nano-IND/TiO₂)

TiO₂ nanoparticles were dispersed in ethanol, followed by ultra-sonication for 1.5 hours in a bath sonicator at 35° C. with a concentration of about 1 g/L. Due to the extremely low solubility of TiO₂ and low time stability of the TiO₂ nanoparticles suspension, the PCA-PEG-PCA copolymers with a concentration of about 10 g/L were immediately mixed with the dispersed TiO₂ using ultrasound for about 2 hours. Due to the interactions between TiO₂ nanoparticles and copolymers, the stability of TiO₂ suspension was significantly increased and free TiO₂ nanoparticles were deposited after approximately 1 hour. The dissolved indoxacarb in acetone with a concentration of about 1 g/L was then, added to the resultant suspension and the admixture were stirred for at least 10 hours at room temperature. Free TiO₂ nanoparticles and free indoxacarb were separated as impurities using a dialysis bag. The resultant solution was used as a stock solution of nano-IND/TiO₂ in the experiments.

### Determination of Loading Capacity of PCA-PEG-PCA Copolymers

A certain amount of nano-IND and nano-IND/TiO₂ were prepared and separately sealed in a dialysis bag. Then, the each dialysis bag was immersed in the phosphate-buffered saline solution (PBS) which was stirred by a magnetic stirrer at a fixed speed at room temperature for about 30 minute. This experiment was done at two pH values (pH of 7 and 10) for the PBS. The concentration of encapsulated indoxacarb in each formulation was determined using UV absorbance at λmax=276 nm.

The percentage of encapsulation was calculated as:

% encapsulation={(total indoxacarb concentration-free indoxacarb concentration)/total indoxacarb concentration}*100

Determination of release rate indoxacarb from nano-formulations

The fluid released from the dialysis bag into the PBS buffer, contained a certain amount of encapsulated indoxacarb. The mixture was stirred for 30 to 400 minutes using a magnetic stirrer at a fixed speed at room temperature. The concentration of the mixture was determined by means of UV absorbance at 268 nm and 276 nm. This was done at a neutral pH (7) for the PBS buffer and the common pH of Lepidopteran gut.

The percentage of indoxacarb released was calculated using following equation:

% release=(free indoxacarb concentration at each sample/total indoxacarb concentration)*100.

### Characterization of Nano-IND and Nano-IND/TiO₂

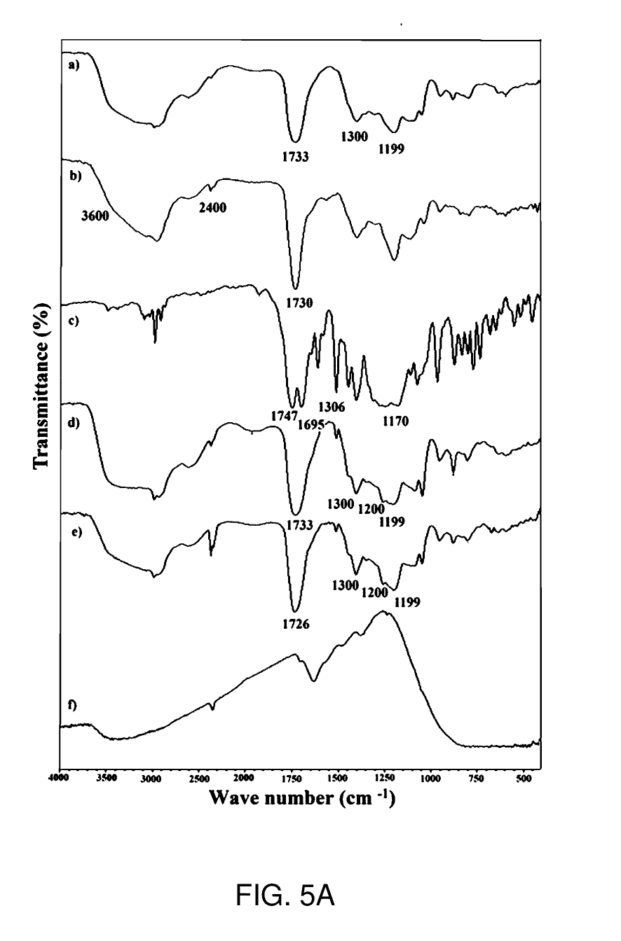

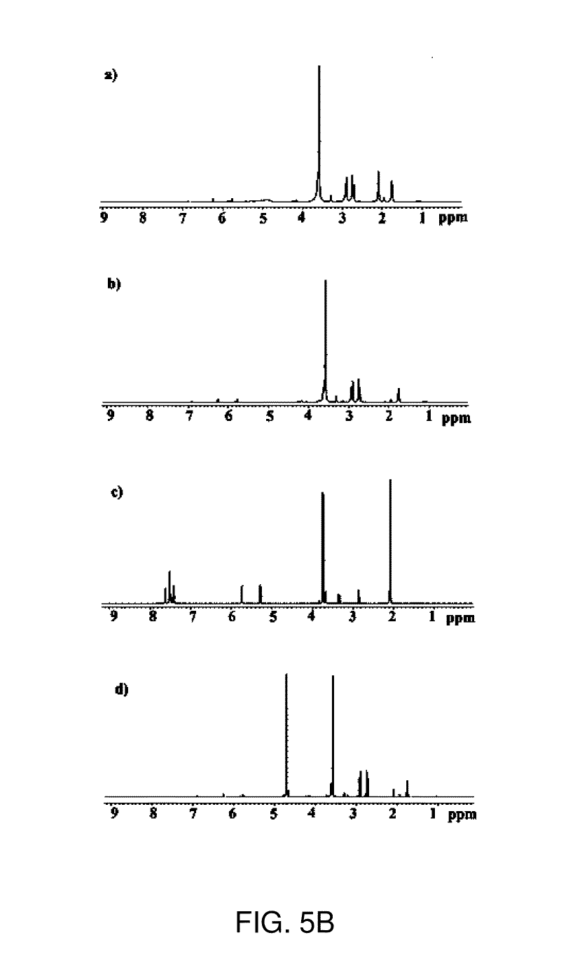

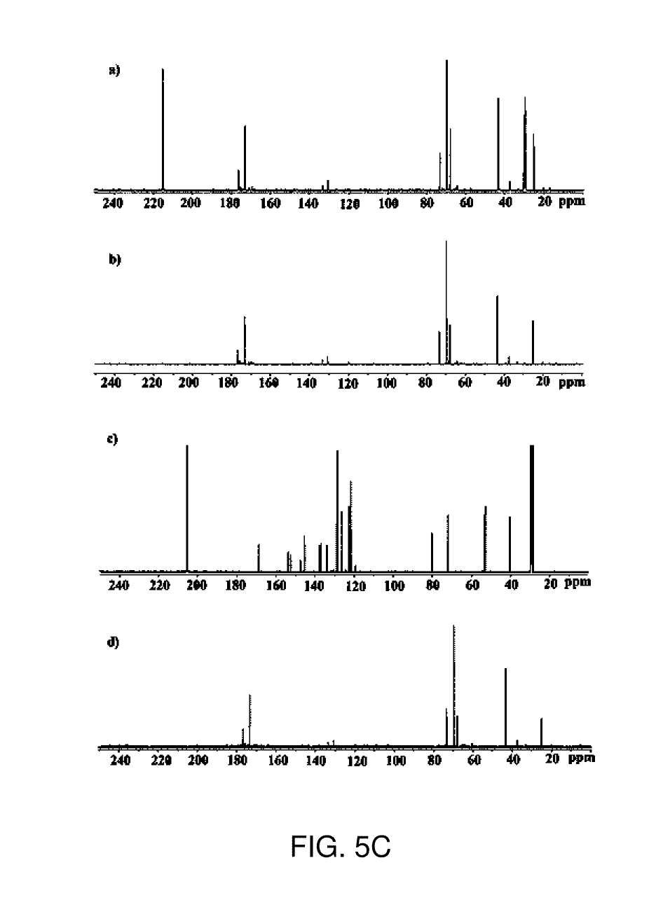

With reference to FIG. 5A of the DRAWINGS, the characteristic peaks of the copolymers IR spectra were as follows: the peaks at 2400-3600 cm⁻¹ and 1730 cm⁻¹ as illustrated in FIG. 5A of the DRAWINGS which is designated by letter (b), resulted from vibrational stretching of the hydroxyl and carbonyl groups of the PCA blocks. The peaks at 1170-1306 cm⁻¹ as illustrated in FIG. 5A of the DRAWINGS, which is designated by letter (c), in indoxacarb IR spectrum resulted from symmetric stretching vibrations of C—O and the peaks at 1695-1747 from the C═C and NO₂ stretching frequencies.

For the main domain or functional groups of linear-dendritic copolymers to interact with the indoxacarb or TiO₂ nanoparticles, they should be carboxyl functional groups of PCA blocks. Accordingly, upon encapsulation of indoxacarb inside molecular self-assemblies of PCA-PEG-PCA copolymers and preparation of nano-IND, the carbonyl peak of the copolymers shifted from 1730 cm⁻¹ to 1726 cm⁻¹, as illustrated in FIG. 5A of the DRAWINGS, which is illustrated by letter (d). Furthermore, the broadening of the absorption bond of carboxyl functional groups of copolymers increased, which confirms the hydrogen bonding between carboxyl functional groups of copolymers and heteroatoms of indoxacarb. Grafting TiO₂ nanoparticles onto PCA-PEG-PCA copolymers shifted this peak from 1730 cm⁻¹ to 1733 cm⁻¹, as illustrated in FIG. 5A of the DRAWINGS, which is designated by letter (a). Also, it changed the pattern of the absorption bond of carboxylic functional groups of copolymers. This result again proves the formation of the hydrogen bonds between hydroxyl functional groups in the surface of TiO₂ nanoparticles and copolymers. When indoxacarb was encapsulated inside molecular self-assemblies of copolymers grafted to TiO₂ nanoparticles, as illustrated in FIG. 5A of the DRAWINGS, which is designated by letter (e), the nano-IND/TiO₂ particles no longer caused a shift in this peak for the copolymers. The peak at 1199-1300 according to FIG. 5A (d) and FIG. 5A (e) is related to C—O groups of indoxacarb when the copolymers was alone or linked to TiO₂ for encapsulation of indoxacarb.

The main reason for the shift in the peak of carbonyl groups from 1730 cm⁻¹ to 1726 cm⁻¹ with reference to FIG. 5A (b) and FIG. 5A (d) of the DRAWING respectively, is the hydrogen bonds between carbonyl functional groups of PCA blocks of copolymers and heteroatoms of indoxacarb. New steric peaks appeared at 1200 cm⁻¹ confirming the presence of nano-IND inside the copolymers. The same shifts occurred for nano-IND/TiO₂ with a slight variation, which confirms the formation of molecular self-assemblies consisting of these three components. These obvious changes suggest that the indoxacarb, copolymers and TiO₂ nanoparticles interacted strongly, and that indoxacarb and TiO₂ actually formed part of the nano-indoxacarb molecular self-assembly.

The ¹H NMR spectra of copolymers as illustrated in FIG. 5B of the DRAWINGS, which is designated by letter (d), exhibits cchemical shifts at 4.7 and 3.6 ppm from the PEG methylene groups and at 2.6-2.8 ppm from the PCA methylene groups. The ¹H NMR spectrum of free indoxacarb with reference to FIG. 5B of the DRAWING, which is designated by letter (c), illustrated signals at 1.8, 2.1, 2.8 and 3.4-3.7 ppm for the methylene groups. It also indicated chemical shifts at 5.3 and 5.7 ppm for the ethylene groups and at 7.4, 7.5 and 7.6 for protons of the benzene ring. The ¹H NMR spectra of nano-IND as illustrated in FIG. 5B of the DRAWINGS, which is designated by letter (b) showed chemical shifts at 6.35, 6.52 ppm related to the benzene ring of indoxacarb and at 1.8-4.2 related to the methylene groups of indoxacarb and all signals correlating with PCA-PEG-PCA copolymers. The ¹H NMR spectrum of nano-IND showed also chemical shifts at 5.7 ppm from the ethylene group of indoxacarb.

The appearance of signals correlated to both copolymers and indoxacarb with shifts in the ¹H NMR spectrum of nano-IND confirms the encapsulation of indoxacarb by the molecular self-assemblies of PCA-PEG-PCA copolymers. Significant shifts in the signals of the aromatic ring show that this portion of indoxacarb interacted with the linear-dendritic copolymers efficiently. The π-π interactions between the benzene ring and carbonyl functional groups is the main interaction, other than hydrogen bonding that was confirmed by the IR spectra. Shifts for methylene groups of indoxacarb that are neighbors of heteroatoms confirm that heteroatoms were included in the hydrogen bonding. The signals for ethylene group, however, did not shift, which confirms that the ethylene group, or the domain of indoxacarb, in which they are included, are not important in the supramolecular interactions. The ¹H NMR spectrum of nano-IND/TiO₂, as illustrated in the implementation of the FIG. 5B of the DRAWINGS which is designated by letter (a), illustrates the same signals addition to chemical shifts at 4.7 from PEG methylene group of copolymer and at 5.3 ppm from the ethylene group of indoxacarb.

In the ¹³C NMR spectra of the PCA-PEG-PCA copolymers, with reference to FIG. 5C of the drawings, which is designated by letter (d), chemical shifts at 175, 170, 64 and 42 ppm correlate with the carbonyl and carbons of the PCA blocks. Chemical shifts at 67-70 ppm result from end methylene groups of PEG and PEG carbons. With reference now to FIG. 5C of the DRAWINGS, which is designated by letter (c), the ¹³C NMR spectra for indoxacarb indicates carbon peaks at 126.4, 129, 129.7, 133.6, 134.5, 140.6 and 155.9 ppm that correlate with the carbons of the aromatic (benzene) rings; signals at 32.5, 40, 52.2, 74, 81, 115.1 and 119 correlate with carbons of the non-aromatic rings. Chemical shifts at 168.5 also correspond to carbonyl group of indoxacarb.

The ¹³0 NMR spectra for nano-IND as illustrated in FIG. 5C of the DRAWINGS, which is designated by letter (b), show chemical shifts at 20.7, 34.6, 38, 46, 60.3, 66.9 and 121.8 ppm that correlate with the aliphatic methylene groups of both PCA-PEG-PCA copolymers and indoxacarb. Chemical shifts at 37.7, 133.6, 134.5, 140.6 and 150.7 ppm correspond to the aromatic rings of indoxacarb. Signals at 166, 168.5, 173.1 and 178.5 correspond to the PCA blocks of copolymers. Interestingly, in the ¹³C NMR spectra of nano-IND/TiO₂ as illustrated in FIG. 5C of the DRAWINGS, which is designated by letter (a), there is a chemical shift at 215 ppm in addition to those observed for nano-IND. There appears to be strong non-covalent interactions between the carboxyl functional groups of the PCA-PEG-PCA copolymers and the surface of the TiO₂ nanoparticles.

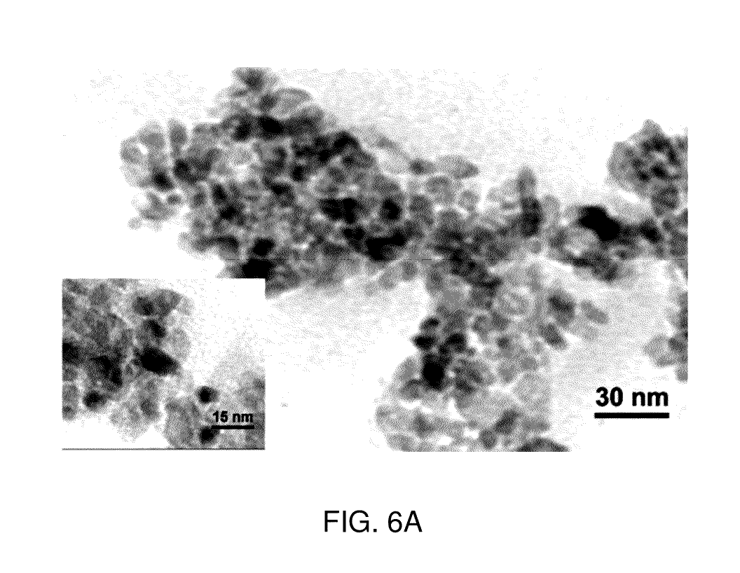

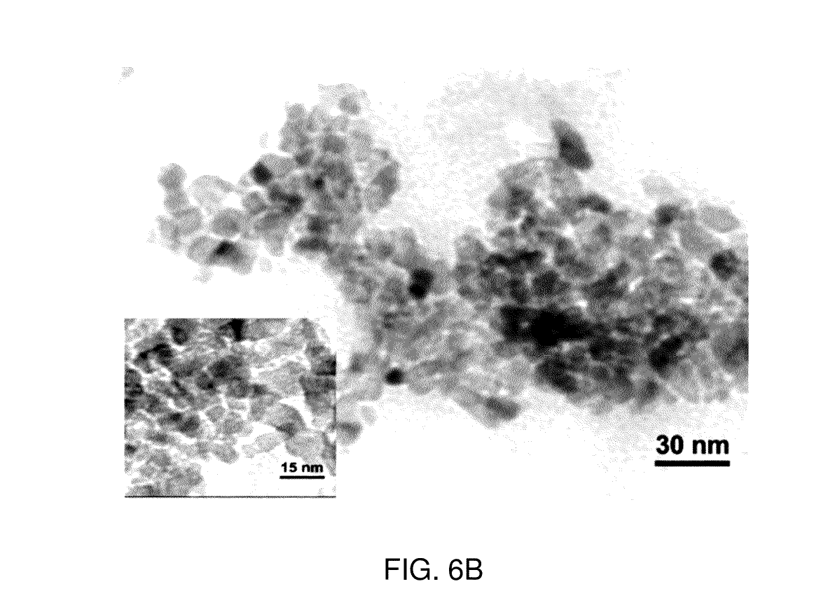

The implementation of the FIG. 6A of the DRAWINGS confirms that the molecular self-assembly of synthesized nano-IND led to the formation of semi-spherical nanoparticles with an average size of 10 nm.

TEM images of semi-spherical nanoparticles of nano-IND/TiO₂ with an average size of 12 nm is illustrated in FIG. 6B of the DRAWINGS. It appears that indoxacarb crystals and TiO₂ nanoparticles are loaded into the nano-sphere core and are surrounded by a PCA-PEG-PCA copolymers shell. These nanoparticles can be observed as darker points in the TEM images, as illustrated in FIG. 6A and FIG. 6B.

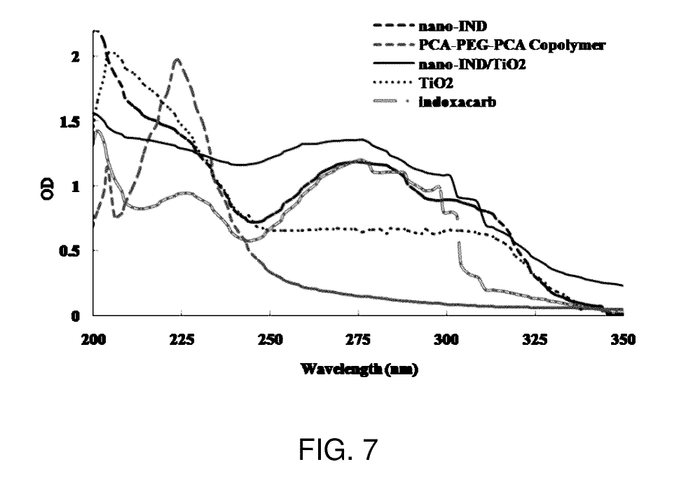

UV-vis spectra of nano-IND and nano-IND/TiO₂ as illustrated in the implementation of the FIG. 7, indicates maximum absorption of indoxacarb with a slight variation, which confirms the encapsulation of indoxacarb via molecular self-assemblies of copolymers and the presence of interactions between the heteroatoms of indoxacarb and PAC-PEG-PCA copolymers.

### Loading and Release Capacity of PCA-PEG-PCA Copolymers Using Nano-IND and Nano-IND/TiO₂

Using nano-IND, the copolymers loading capacities at pH values of 7.0 and 10.0 were 45% and 50%, respectively. The application of nano-IND/TiO₂ at pH values of 7.0 and 10 resulted in 37% and 47% of indoxacarb being loaded onto the copolymers, respectively. It can be concluded that the loading capacity for nano-IND/TiO₂ formulation was lower compared to when TiO₂ nanoparticles are not used (nano-IND). The highest loading capacity was achieved at pH 10.

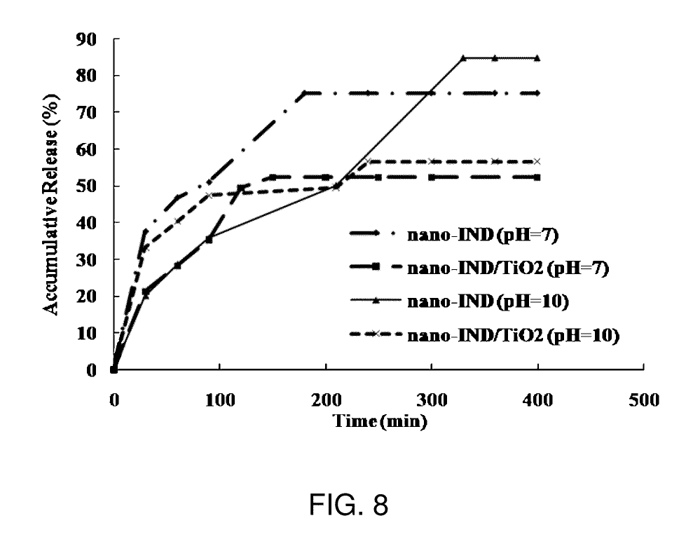

As illustrated in FIG. 8 of the DRAWINGS, the percentage of accumulative release of indoxacarb from the nano-IND/TiO₂ system at both pH values was lower than that from nano-IND. This is caused by the degradation of a considerable amount of indoxacarb under sunlight as previously confirmed. The selective action of nano-IND at the pH of G. pyloalis gut (the pH is about 10) compared to neutral pH (higher loading capacity and higher release time of indoxacarb), confirms its usage as a pesticide formulation compatible with the objectives of sustainable agriculture. The results of the leaf dip bioassay further verify this claim.

Insecticide Efficiency of Synthesized Nano-IND andnano-IND/TiO₂

The implementation of TABLE 3 illustrates 100% mortality for an exposure time of 4 days at 4 ppm for free indoxacarb, 0.5 ppm for nano-IND and 0.4 ppm for nano-IND/TiO_{2.} ANOVA and mean comparison in a split-plot in time design (combined analysis) of leaf dip bioassay results showed no significant difference between the 4^{th} and 5^{th} days of the exposure, when bulk indoxacarb was used. Mortality for nano-IND significantly increased on the 5^{th} day of the exposure. To have effective mortality, less active chemical agent was consumed in case of using nano-IND/TiO₂ compared to nano-IND, due to its TiO₂ toxicity.

Since TiO₂ suspension alone caused mortality in the test insects, the percentage of mortality significantly decreased at each concentration of nano-IND/TiO₂ that was caused solely by toxicity of nanoparticles of indoxacarb (not for TiO₂ toxicity) significantly decreased.

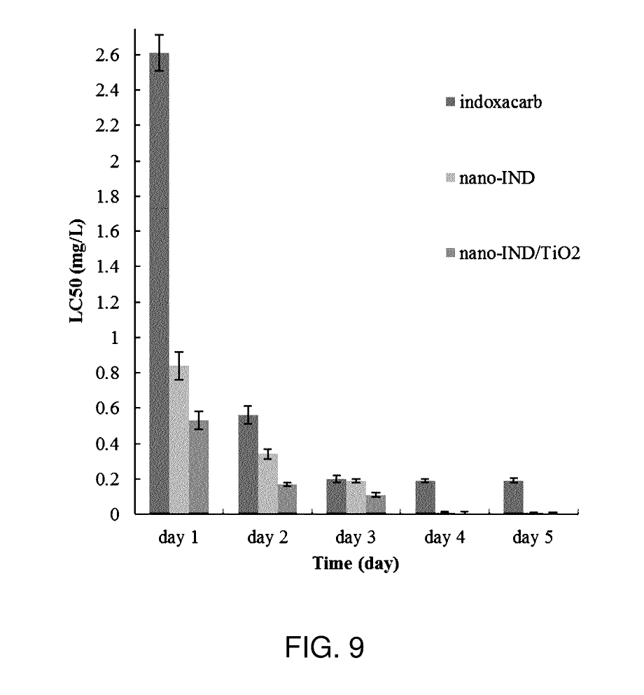

Moreover, a comparison of the amount of LC_{50S} in the bulk indoxacarb, nano-IND, and nano-IND/TiO₂ as illustrated in FIG. 9 of DRAWINGS, indicated that as the length of exposure increased, the amount of LC₅₀ in nano-IND decreased more than that in free indoxacarb.

With further reference to FIG. 9 of the DRAWINGS, after 3 days, the LC₅₀ for nano-IND was at least 1.5 fold lower than that of the bulk form of indoxacarb; after 4 days this amount was at least 19 fold lower and, after 5 days, at least 21-fold lower than that of the bulk form. Using nano-IND/TiO₂ decreased LC₅₀ even more than using nano-IND, but the amount of LC₅₀ for nano-IND/TiO₂ (without mortality caused by TiO₂) significantly increased. Therefore, the bioassay results confirm the better performance of nano-IND compared to the nano-IND/TiO₂ Statistical analysis showed that when both forms of nano-indoxacarb were used in the bioassay, increasing the concentration overexposure time (5 days for nano-IND and 4 days for nano-IND/TiO₂) significantly increase the mortality. These in vivo results confirmed the slow release of the effective materials from the molecular self-assemblies as well as longer remaining of the effective material on the target site which verify the in vitro results as illustrated in FIG. 7 of the DRAWINGS. This results in increasing of control time and decreasing the amount of consumed pesticide.

TABLE 3
Mortality percentage of newly ecdysed fifth instar larvae of G. pyloalis by leaf dip bioassay method over the five days.
(p > 0.05). Means followed by similar letters showed no significantly difference from each other by Tukey's test (p < 0.05).

| | Concentrations | % mortality at times (h) after treatment | | | | |
|---|---|---|---|---|---|---|
| Formula | (ppm) | 24 h | 48 h | 72 h | 96 h | 120 h |
| Indoxacarb | 4 | 55 ± 3.87^{bcdefg} | 71.98 ± 2.92^{abcd} | 88.32 ± 7.57^{ab} | 100 ± 0^{a} | 100 ± 0^{a} |
| | 2.8 | 51.32 ± 8.9^{cdefg} | 68.82 ± 5.05^{abcde} | 76.66 ± 4.27^{abcd} | 88.32 ± 6.55^{ab} | 88.4 ± 6.57^{ab} |
| | 1.5 | 44.16 ± 8.22^{defg} | 62 ± 2.23^{bcdef} | 74.4 ± 2.58^{abcd} | 83 ± 2.23^{abc} | 83.6 ± 2.07^{abc} |
| | 0.82 | 34.32 ± 7.45^{efg} | 51.5 ± 9.25^{cdefg} | 63.58 ± 7.84^{bcdef} | 76 ± 2.73^{abcd} | 77 ± 2.23^{abcd} |
| | 0.45 | 34 ± 10.29^{efg} | 47.9 ± 10^{cdefg} | 59 ± 19.97^{bcdef} | 63 ± 12.32^{bcdef} | 64 ± 12.67^{bcdef} |
| | 0.25 | 21 ± 2.91^{g} | 26.61 ± 7.99^{gf} | 56.4 ± 8.84^{bcdef} | 61 ± 8.73^{bcdef} | 62 ± 7.62^{bcdef} |
| Nano-IND | 0.5 | 36 ± 2.73^{ghi} | 57.6 ± 4.14^{e} | 78.2 ± 0.54^{bc} | 100 ± 0^{a} | 100 ± 0^{a} |
| | 0.31 | 30 ± 3.53^{hijk} | 50 ± 5^{efg} | 72 ± 2.23^{cd} | 96 ± 2.73^{a} | 100 ± 0^{a} |
| | 0.2 | 16 ± 2.73^{klm} | 36.4 ± 2.04^{ghi} | 62 ± 2.34^{de} | 94.4 ± 1.78^{a} | 99.2 ± 0.89^{a} |
| | 0.125 | 10 ± 3.53l^{m} | 30.4 ± 1.64^{hij} | 56.2 ± 0.48^{ef} | 91.8 ± 0.89^{ab} | 95 ± 2.34^{a} |
| | 0.08 | 6 ± 2.44^{m} | 24 ± 5.16^{ijkl} | 48 ± 3.41^{efg} | 89.8 ± 0.47^{ab} | 90.2 ±0.25^{ab} |
| | 0.05 | 5 ± 2.5^{m} | 18.2 ± 0.89^{jklm} | 42.4 ± 5.25^{fgh} | 74 ± 5.7^{cd} | 85 ± 2.5^{ab} |
| Nano- | 0.4 | 46.66 ± 5.4^{efgh} | 73.32 ± 5.4^{bc} | 86.64 ± 2.04^{ab} | 100 ± 0^{a} | 100 ± 0^{a} |
| IND/TiO₂ | 0.3 | 18.32 ± 2.7^{jk} | 65 ± 3.06^{cde} | 73.32 ± 2.04^{bc} | 96.64 ± 1.82^{a} | 97.32 ± 1.94^{a} |
| | 0.2 | 33.32 ± 5.4^{hij} | 60 ± 3.53^{cdef} | 66.64 ± 4.08^{cd} | 93.32 ± 3.65^{a} | 95.6 ± 1.93^{a} |
| | 0.1 | 25 ± 3.06^{ijk} | 53.32 ± 2.04^{defg} | 63.32 ± 1.82^{cde} | 95.32 ± 2^{a} | 95.46 ± 1.97^{a} |
| | 0.07 | 21.66 ± 6.39^{jk} | 33.33 ± 4.71^{hij} | 43.32 ± 3.33^{ghi} | 86.64 ± 7.30^{ab} | 88.84 ± 5.37^{ab} |
| | 0.04 | 10 ± 3.53^{k} | 26.64 ± 5.4^{ijk} | 36.64 ± 6.23^{ghij} | 89 ± 1^{ab} | 89 ± 1^{ab} |

As is known to those skilled in the art, an insect's gut is the first location that interacts with a toxic substance that enters the body orally, thus, enzyme production by gut cells is an adaptation that defends against pesticides. The polarity of PCA-PEG-PCA copolymers covered by nano-indoxacarb formulations helped insecticide molecules to be absorbed by the cells of the gut membrane and penetrate to the hemolymph faster than the bulk form of indoxacarb, which protected the molecules from being affected by detoxifying enzymes. In addition, the small pores of the peritrophic membrane can prevent the free movement of large food molecules; thus, the conversion of bulk pesticides to nano-form could allow them to penetrate the cell membranes and avoid being affected by digestive and detoxifying enzymes.

### Photocatalytic Degradation of Indoxacarb

The percentage of degradation of indoxacarb in four formulation of indoxacarb under UV light and over 18 hours, as set forth in TABLE 4 herein below, indicates that increasing the indoxacarb concentration in each sample, significantly increased degradation under UV light. Since the different concentrations for the samples (free indoxacarb, nano-IND, nano-IND/TiO_{2,} and indoxacarb/TiO₂) were prepared from one stock solution, this must have been due to an increase in the amount of accompanying agents such as TiO₂ and/or PCA-PEG-PCA copolymers. While the degradation of bulk indoxacarb was very slow in direct photolysis compared to other treatments and as the maximum amount of bulk indoxacarb removed at all concentrations (10, 20, 30, 40 and 50 ppm) after 18 h was about 25%, the observed high decomposition under UV can be exclusively attributed to the photocatalytic reaction of the materials used for the indoxacarb formulations.

A maximum of 75% removal of the insecticide was achieved in the presence of TiO₂ nanoparticles after approximately 18 hours in UV light. In the same conditions and using nano-IND/TiO₂, 100% degradation of indoxacarb was achieved. Interestingly, when nano-IND was applied under UV light without a catalyst or reagent such as TiO_{2,} about 88% of the initial indoxacarb degraded. Although, in the presence of both UV light and TiO₂ nanoparticles, degradation of indoxacarb was significantly greater than that for direct photolysis, these values increased when two types of nano-indoxacarb (nano-IND and nano-IND/TiO₂) were used separately. This confirms that PCA-PEG-PCA molecular self-assemblies as biomaterials are more promising candidates to degrade organic compounds compared to photocatalytic nanoparticles.

The percentage of degradation of indoxacarb in four indoxacarb formulations as nano-IND/TiO₂>nano-IND>indoxacarb/TiO_{2,} under natural light and over 10 days is described in more detail in TABLE 5 herein below. As is known to those skilled in the art, exposure to UV radiation may cause significant degradation of many materials. On one hand, exposure of aqueous solutions of materials, such as indoxacarb to UV radiation leads to the primary species e_{aq}⁻, HO., H., H₂ or H₂O₂. In this way, HO. and/or H. may take part in the degradation of indoxacarb. On the other hand, photons within the UV spectrum, with their short wavelength, possess large amounts of energy. When these rays reach a material such as indoxacarb, this energy can be absorbed by the material and transfer to the molecules or atoms within the structure. Hence, if the addition of energy is sufficient, this can lead to breaking of the molecular bonds. With further reference to FIG. 7 of the DRAWINGS and the results set forth herein, it is indicated that PCA-PEG-PCA copolymers has good absorbance in UV region; thus when this copolymers covered nano-indoxacarb (i.e. nano-IND), absorbance of UV light was increased. Therefore, nanoparticles of indoxacarb were exposed to more energy of UV photons hereby the possibility of further degradation will be provided. It is evident that in the case of nano-IND/Ti₂, due to the use of TiO₂ nanoparticles as a photo catalyst, more degradation was obtained than that in the case of nano-IND. The use of catalysts and chemicals combined with UV light can produced the ability of degradation; and the results of photo degradation of IND/TiO₂ also verified this theory. However, the significant degradation of indoxacarb, by merely applying biodegradable linear-dendritic copolymers (88%) is a new and promising approach for the removal of environmental pollutants. Furthermore, as direct photo degradation needs very simple and cheap experimental set up, it has been supposed of as a possible alternative of photocatalytic degradation.

While the present application has been illustrated by the description of the implementations thereof, and while the implementations have been described in detail, it is not the intention of the Applicant to restrict or in any way limit the scope of the appended claims to such detail. Additional advantages and modifications will readily appear to those skilled in the art. Therefore, the application in its broader aspects is not limited to the specific details, representative apparatus and method, and illustrative examples shown and described. Accordingly, departures may be made from such details without departure from the breadth or scope of the applicant's concept. Furthermore, although the present application has been described in connection with a number of exemplary implementations and implementations, the present application is not so limited but rather covers various modifications and equivalent arrangements, which fall within the purview of the appended claims.

TABLE 4
The percentage of degradation of indoxacarb in four formulations of indoxacarb
with different initial concentrations, under UV light and over 18 hours

| | Formula¹ | | | | | | | | | |
|---|---|---|---|---|---|---|---|---|---|---|
| | Indoxacarb | | | | | Nano-IND | | | | |
| | Con² | | | | | | | | | |
| Time³ | 10 | 20 | 30 | 40 | 50 | 10 | 20 | 30 | 40 | 50 |
| 1 h | 2.3 ± | 6.24 ± | 9.32 ± | 11.47 ± | 9.23 ± | 45.67 ± | 43.5 ± | 44.41 ± | 40.5 ± | 43.37 ± |
| | 0.44 | 0.34 | 0.45 | 0.67 | 0.33 | 0.94 | 0.7 | 0.57 | 0.7 | 0.53 |
| 3 h | 7.44 ± | 12.49 ± | 13.07 ± | 15.04 ± | 13.34 ± | 51.82 ± | 62.33 ± | 74.06 ± | 76.48 ± | 71.12 ± |
| | 0.63 | 0.69 | 0.11 | 0.06 | 0.48 | 2.58 | 0.46 | 0.09 | 0.68 | 0.17 |
| 6 h | 10.26 ± | 18.9 ± | 23.34 ± | 24.26 ± | 21.02 ± | 60.48 ± | 73.16 ± | 82.37 ± | 85.30 ± | 78.37 ± |
| | 0.37 | 0.12 | 0.48 | 0.37 | 0.03 | 0.68 | 0.23 | 0.53 | 0.43 | 0.53 |
| 18 h | 13.07 ± | 22.03 ± | 25.21 ± | 25.39 ± | 21.02 ± | 88.14 ± | 82.33 ± | 85.17 ± | 86.52 ± | 85.31 ± |
| | 0.11 | 0.05 | 0.31 | 0.55 | 0.03 | 0.2 | 0.46 | 0.24 | 0.74 | 0.43 |
| | Formula¹ | | | | | | | | | |
| | Nano-IND/TiO₂ | | | | | Indoxacarb/TiO₂ | | | | |
| | Con² | | | | | | | | | |
| Time³ | 10 | 20 | 30 | 40 | 50 | 10 | 20 | 30 | 40 | 50 |
| 1 h | 58.27 ± | 46.33 ± | 59.24 ± | 54.33 ± | 41.43 ± | 12.09 ± | 14.31 ± | 20.34 ± | 27.29 ± | 31.43 ± |
| | 0.37 | 0.47 | 0.34 | 0.47 | 0.61 | 0.13 | 0.44 | 0.48 | 0.41 | 0.61 |
| 3 h | 68.14 ± | 74.33 ± | 69.41 ± | 71.47 ± | 65.31 ± | 17.03 ± | 39.01 ± | 45.34 ± | 54.15 ± | 62.25 ± |
| | 0.2 | 0.46 | 0.58 | 0.66 | 0.44 | 0.05 | 0.01 | 0.48 | 0.21 | 0.35 |
| 6 h | 97.28 ± | 86.33 ± | 75.43 ± | 74.41 ± | 74.18 ± | 48.39 ± | 63.2 ± | 61.1 ± | 68.05 ± | 69.18 ± |
| | 0.39 | 0.47 | 0.6 | 0.57 | 0.26 | 0.55 | 0.29 | 0.14 | 0.07 | 0.26 |
| 18 h | 100 | 95.5 ± | 84.24 ± | 81.50 ± | 84.50 ± | 51.1 ± | 65.42 ± | 68.05 ± | 68.48 ± | 75.31 ± |
| | | 0.7 | 0.34 | 0.71 | 0.7 | 0.15 | 0.6 | 0.07 | 0.68 | 0.44 |

¹Four formulations of indoxacarb: bulk indoxacarb, nano-IND, nano-IND/TiO2 and indoxacarb/TiO2.
²Concentrations of different formulations of indoxacarb used in photocatalytic experiments (ppm).
³Time of exposure of five concentrations of different indoxacarb formulations under UV light in the photocatalytic experiments (hours).
⁴Values were expressed as the mean ± standard deviation (SD).

TABLE 5
The percentage of degradation of indoxacarb in four indoxacarb
formulations with different initial concentrations, under natural light and over 10 days.
% photo degradation of indoxacarb in the batch reactor under natural light

| | Formula¹ | | | | | | | | | |
|---|---|---|---|---|---|---|---|---|---|---|
| | Indoxacarb | | | | | Nano-IND | | | | |
| | Con² | | | | | | | | | |
| Time³ | 10 | 20 | 30 | 40 | 50 | 10 | 20 | 30 | 40 | 50 |
| 2 d | 16.33 ± | 22.26 ± | 26.23 ± | 22.26 ± | 21.23 ± | 42.11 ± | 60.13 ± | 66.16 ± | 69.26 ± | 74.09 ± |
| | 0.47 | 0.37 | 0.33 | 0.37 | 0.32 | 0.15 | 0.19 | 0.23 | 0.37 | 0.13 |
| 4 d | 19.02 ± | 23.47 ± | 29.2 ± | 29.28 ± | 26.35 ± | 44.22 ± | 61.32 ± | 70.2 ± | 74.1 ± | 77.2 ± |
| | 0.03 | 0.66 | 0.29 | 0.4 | 0.49 | 0.31 | 0.45 | 0.28 | 0.15 | 0.29 |
| 6 d | 21.21 ± | 25.17 ± | 31.18 ± | 31.34 ± | 30.18 ± | 62.11 ± | 63 ± | 70.2 ± | 75.39 ± | 78.03 ± |
| | 0.3 | 0.24 | 0.26 | 0.48 | 0.25 | 1.15 | 0.01 | 0.28 | 0.55 | 0.04 |
| 8 d | 23.4 ± | 29.28 ± | 33.16 ± | 36.3 ± | 32.23 ± | 66.33 ± | 65.37 ± | 71.21 ± | 76.28 ± | 78.85 ± |
| | 0.57 | 0.29 | 0.23 | 0.43 | 0.32 | 0.47 | 0.53 | 0.3 | 0.39 | 0.2 |
| 10 d | 30.47 ± | 33.4 ± | 36.13 ± | 39.21 ± | 37.38 ± | 84.22 ± | 79.22 ± | 83.33 ± | 85.07 ± | 87.04 ± |
| | 0.67 | 0.56 | 0.19 | 0.3 | 0.54 | 0.31 | 0.31 | 0.47 | 0.11 | 0.06 |
| | Formula¹ | | | | | | | | | |
| | Nano-IND/TiO₂ | | | | | Indoxacarb/TiO₂ | | | | |
| | Con² | | | | | | | | | |
| Time³ | 10 | 20 | 30 | 40 | 50 | 10 | 20 | 30 | 40 | 50 |
| 2 d | 44.22 ± | 57.26 ± | 67.17 ± | 71.43 ± | 81.14 ± | 37.38 ± | 53.21 ± | 63.13 ± | 64.14 ± | 59.35 ± |
| | 0.31 | 0.37 | 0.24 | 0.61 | 0.2 | 0.54 | 0.3 | 0.18 | 0.2 | 0.5 |
| 4 d | 46.33 ± | 64.19 ± | 75.25 ± | 76.28 ± | 83.11 ± | 48.44 ± | 63 ± | 69.19 ± | 70.11 ± | 74.37 ± |
| | 0.47 | 0.27 | 0.36 | 0.39 | 0.15 | 0.62 | 0.01 | 0.27 | 0.16 | 0.53 |
| 6 d | 64.22 ± | 69.43 ± | 77.27 ± | 77.17 ± | 83.11 ± | 59.5 ± | 65.37 ± | 72.22 ± | 74.2 ± | 79.06 ± |
| | 0.31 | 0.61 | 0.38 | 0.24 | 0.15 | 0.7 | 0.53 | 0.31 | 0.28 | 0.08 |
| 8 d | 73.16 ± | 77.54 ± | 86.36 ± | 84.18 ± | 85.08 ± | 71.05 ± | 73.48 ± | 79.29 ± | 82.07 ± | 85.21 ± |
| | 0.23 | 0.76 | 0.51 | 0.26 | 0.11 | 0.07 | 0.68 | 0.41 | 0.1 | 0.3 |
| 10 d | 86.33 ± | 80.41 ± | 87.37 ± | 88.14 ± | 90.48 ± | 73.16 ± | 76.35 ± | 82.32 ± | 83.16 ± | 85.46 ± |
| | 0.47 | 0.58 | 0.53 | 0.19 | 0.68 | 0.23 | 0.5 | 0.46 | 0.23 | 0.65 |

¹Four formulations of indoxacarb: bulk indoxacarb, nano-IND, nano-IND/TiO₂ and indoxacarb/TiO₂.
²Concentrations of different formulations of indoxacarb used in photocatalytic experiments (ppm).
³Time of exposure of five concentrations of different indoxacarb formulations under natural light in the photocatalytic experiments (day).
⁴Values were expressed as the mean ± standard deviation (SD).

1. An encapsulated formulation comprising:
an active agent, wherein said active agent includes at least one chemical pesticide; and
at least one encapsulating material, wherein the encapsulating material includes at least one triblock copolymer and is configured to encapsulate the active agent.

2. The encapsulated formulation according to claim 1, wherein the encapsulated formulation is a biocompatible formulation.

3. The encapsulated formulation according to claim 1, wherein said at least one chemical pesticide is selected from a group consisting of insecticide, herbicide, algicides or algaecides, miticides, acaricides, rodenticides, virucides, nematicide, termiticide, molluscicide, antimicrobial, fungicide, disinfectant (antimicrobial), sanitizer and derivatives thereof.

4. The encapsulated formulation according to claim 2, wherein said at least one chemical pesticide is insecticide.

5. The encapsulated formulation of claim 1, wherein said at least one triblock copolymer is a linear dendritic copolymer.

6. The encapsulated formulation of claim 1, wherein the type of said at least one triblock copolymer is ABA.

7. The encapsulated formulation according to claim 5, wherein said ABA triblock linear-dendritic copolymers comprises poly (citric acid) (PCA) as A block and poly (ethylene glycol) (PEG) as B block.

8. The encapsulated formulation according to claim 1, wherein said triblock linear dendritic copolymer has self-assembly properties.

9. The encapsulated formulation according to claim 1, wherein the encapsulated formulation is a photodegradable formulation.

10. The encapsulated formulation according to claim 1, further comprising at least one photocatalytic compound.

11. The encapsulated formulation according to claim 10, wherein said at least one photo catalytic compound includes TiO_{2.}

12. The encapsulated formulation according to claim 10, wherein said photocatalytic compound is grafted to said at least one triblock copolymer.

13. The encapsulated formulation according to claim 1, wherein said active agent is about 20 to about 80 weight percent of the total weight of the encapsulated formulation.

14. The encapsulated formulation according to claim 1, wherein said at least one triblock copolymer has self-assembly property.

15. The encapsulated formulation according to claim 1, wherein the formulation enables controlled release of the active agent.

16. The encapsulated formulation according to claim 1, wherein the encapsulated formulation has an average size of about 10 nm to about 20 nm.

17. The encapsulated formulation according to claim 1, wherein the formulation has a pH dependent selective action.

18. A method for preparing an encapsulated formulation, the method comprising steps of:
a) preparing at least one encapsulating material, wherein said encapsulating material comprises of at least one triblock copolymer;
b) dissolving the prepared encapsulating material from step (a) in an organic solvent;
c) dissolving an active agent in an organic solvent, wherein said active agent comprises at least one chemical pesticide;
d) mixing the dissolved encapsulating material from step (b) with the dissolved active agent from step (a);
e) removing impurities from a mixture resulting from the step (d) to form the encapsulated formulation.

19. The method according to claim 18, wherein said at least one triblock copolymer is a linear dendritic copolymer.

20. The method according to claim 19, wherein a type of said at least one triblock copolymer is ABA.

21. The method according to claim 18, wherein said at least one chemical pesticide is selected from a group consisting of insecticide, herbicide, algicides or algaecides, miticides, acaricides, rodenticides, virucides, nematicide, termiticide, molluscicide, antimicrobial, fungicide, disinfectant (antimicrobial), sanitizer, and derivatives thereof.

22. The method according to claim 21, wherein said at least one chemical pesticide is insecticide.

23. The method according to claim 18, wherein said active component is about 30 to about 80 weight percent of the total weight of the encapsulated formulation.

24. The method according to claim 18, wherein the encapsulated formulation has an average size of about 10 nm to about 20 nm.

25. The method according to claim 18, further comprising steps of:
f) dispersing at least one photocatalytic compound in an organic solvent;
g) ultrasonicating of said dispersed photocatalytic compound of step f);
h) grafting the prepared at least one encapsulating material from step a) with the ultrasonicated photo catalytic compound from step g);
i) mixing said dissolved active component obtained from step a) with the grafted component of step h); and
j) removing impurities from a mixture resulting from the step i) to form the encapsulated formulation.

26. The method according to claim 25, wherein the encapsulated formulation has an average size of about 10 nm to about 20 nm.

27. The method according to claim 25, wherein said at least one photocatalytic compound includes TiO₂.

28. The method according to claim 18, wherein a remaining portion of the mixture resulting from the step e) forms the encapsulated formulation.

29. The method according to claim 18, wherein the organic solvent in the step a) includes ethanol.

30. The method according to claim 18, wherein the organic solvent in the step a) includes water.

31. The method according to 18, wherein the organic solvent in the step c) includes acetone.
